(19) United States
(12) Patent Application Publication
(10) Pub. No.: US 2025/0016558 A1
(43) Pub. Date: Jan. 9, 2025

(54) REFERENCE SIGNAL SECURITY

(71) Applicant: QUALCOMM INCORPORATED, San Diego, CA (US)

(72) Inventors: Alexandros MANOLAKOS, Athens (GR); Aziz GHOLMIEH, Del Mar, CA (US); Soo Bum LEE, San Diego, CA (US); Gavin Bernard HORN, La Jolla, CA (US)

(21) Appl. No.: 18/708,184

(22) PCT Filed: Dec. 20, 2022
(86) PCT No.: PCT/US2022/053562

§ 371 Date: May 7, 2024

(30) Foreign Application Priority Data
Jan. 21, 2022 (GR) 20220100058

(51) Int. Cl. H04W 12/043; H04L 5/00; H04W 12/63; H04W 72/12

(52) U.S. Cl. CPC H04W 12/043; H04L 5/0051; H04W 12/63; H04W 72/12

(57) ABSTRACT

A reference signal transmission method includes: determining, at a network entity, a signal configuration of a transmission signal that comprises at least one decoding portion and at least one reference signal portion, where the signal configuration comprises a transmission schedule of the at least one decoding portion and the at least one reference signal portion, where each of the at least one decoding portion comprises decoding information to decode a corresponding one of the at least one reference signal portion, where each of the at least one decoding portion is scheduled in one or more first symbols and the corresponding one of the at least one reference signal portion is scheduled in one or more second symbols, and where none of the one or more first symbols is before any of the one or more second symbols; and transmitting, from the network entity, the transmission signal.

### CROSS-REFERENCE TO RELATED APPLICATIONS

This application claims the benefit of Greek patent application No. 20220100058, filed Jan. 21, 2022, entitled “REFERENCE SIGNAL SECURITY,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example network includes: a transceiver: a memory; and a processor, communicatively coupled to the memory and the transceiver, configured to: determine a signal configuration of a transmission signal that includes at least one decoding portion and at least one reference signal portion, where the signal configuration includes a transmission schedule of the at least one decoding portion and the at least one reference signal portion, where each of the at least one decoding portion includes decoding information to decode a corresponding one of the at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols; and transmit, via the transceiver, the transmission signal.

An example reference signal transmission method includes: determining, at a network entity, a signal configuration of a transmission signal that includes at least one decoding portion and at least one reference signal portion, where the signal configuration includes a transmission schedule of the at least one decoding portion and the at least one reference signal portion, where each of the at least one decoding portion includes decoding information to decode a corresponding one of the at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols; and transmitting, from the network entity, the transmission signal.

Another example network entity includes: means for determining a signal configuration of a transmission signal that includes at least one decoding portion and at least one reference signal portion, where the signal configuration includes a transmission schedule of the at least one decoding portion and the at least one reference signal portion, where each of the at least one decoding portion includes decoding information to decode a corresponding one of the at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols; and means for transmitting the transmission signal.

An example non-transitory, processor-readable storage medium includes processor-readable instructions to cause a processor of a network entity to: determine a signal configuration of a transmission signal that includes at least one decoding portion and at least one reference signal portion, where the signal configuration includes a transmission schedule of the at least one decoding portion and the at least one reference signal portion, where each of the at least one decoding portion includes decoding information to decode a corresponding one of the at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols; and transmit the transmission signal.

An example user equipment includes: a transceiver: a memory; and a processor, communicatively coupled to the memory and the transceiver, configured to: obtain a transmission schedule of a transmission signal including at least one decoding portion and at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols: receive, via the transceiver, the transmission signal, where each of the at least one decoding portion includes decoding information to decode a corresponding one of the at least one reference signal portion: determine, from each of the at least one decoding portion, the decoding information: decode each of the at least one reference signal portion using the decoding information of a corresponding one of the at least one decoding portion, to produce a decoded signal; and determine a reference signal measurement using the decoded signal.

An example reference signal measurement method includes: obtaining, at a user equipment, a transmission schedule of a transmission signal including at least one decoding portion and at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols: receiving the transmission signal at the user equipment, where each of the at least one decoding portion includes decoding information to decode a corresponding one of the at least one reference signal portion: determining the decoding information at the user equipment from each of the at least one decoding portion: decoding, at the user equipment, each of the at least one reference signal portion using the decoding information of a corresponding one of the at least one decoding portion, to produce a decoded signal; and determining, at the user equipment, a reference signal measurement using the decoded signal.

Another example user equipment includes: means for obtaining a transmission schedule of a transmission signal including at least one decoding portion and at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols: means for receiving the transmission signal, where each of the at least one decoding portion includes decoding information to decode a corresponding one of the at least one reference signal portion: means for determining the decoding information from each of the at least one decoding portion: means for decoding each of the at least one reference signal portion using the decoding information of a corresponding one of the at least one decoding portion, to produce a decoded signal; and means for determining a reference signal measurement using the decoded signal.

Another example non-transitory, processor-readable storage medium includes processor-readable instructions to cause a processor of a user equipment to: obtain a transmission schedule of a transmission signal including at least one decoding portion and at least one reference signal portion, where each of the at least one decoding portion is scheduled in one or more first symbols of the transmission schedule and the corresponding one of the at least one reference signal portion is scheduled in one or more second symbols of the transmission schedule, and where none of the one or more first symbols is before any of the one or more second symbols: receive the transmission signal, where each of the at least one decoding portion includes decoding information to decode a corresponding one of the at least one reference signal portion: determine the decoding information from each of the at least one decoding portion: decode each of the at least one reference signal portion using the decoding information of a corresponding one of the at least one decoding portion, to produce a decoded signal; and determine a reference signal measurement using the decoded signal.

Another example network entity includes: a transceiver: a memory; and a processor, communicatively coupled to the memory and the transceiver, configured to: produce a commitment sequence by applying a commitment scheme to a first reference signal: transmit, via the transceiver, the commitment sequence; and transmit, via the transceiver after the commitment sequence is transmitted, a transmission signal including the first reference signal.

Another example reference signal transmission method includes: producing a commitment sequence by applying, at a network entity, a commitment scheme to a first reference signal: transmitting, from the network entity, the commitment sequence; and transmitting, from the network entity after the commitment sequence is transmitted, a transmission signal including the first reference signal.

Another example network entity includes: means for producing a commitment sequence by applying a commitment scheme to a first reference signal: means for transmitting the commitment sequence; and means for transmitting, after the commitment sequence is transmitted, a transmission signal including the first reference signal.

Another example non-transitory, processor-readable storage medium includes processor-readable instructions to cause a processor of a network entity to: produce a commitment sequence by applying a commitment scheme to a first reference signal; transmit the commitment sequence; and transmit, after the commitment sequence is transmitted, a transmission signal including the first reference signal.

Another example user equipment includes: a transceiver: a memory; and a processor, communicatively coupled to the memory and the transceiver, configured to: receive a reference signal from a network entity: receive, from the network entity, a commitment sequence corresponding to the reference signal and to a commitment scheme: apply a function to the reference signal to produce a candidate sequence, the function corresponding to the commitment scheme; and determine whether the candidate sequence has an acceptable relationship with respect to the commitment sequence.

An example reference signal verification method includes: receiving a reference signal at a user equipment from a network entity: receiving, at the user equipment from the network entity, a commitment sequence corresponding to the reference signal and to a commitment scheme: applying, at the user equipment, a function to the reference signal to produce a candidate sequence, the function corresponding to the commitment scheme; and determining, at the user equipment, whether the candidate sequence has an acceptable relationship with respect to the commitment sequence.

Another example user equipment includes: means for receiving a reference signal from a network entity: means for receiving, from the network entity, a commitment sequence corresponding to the reference signal and to a commitment scheme: means for applying a function to the reference signal to produce a candidate sequence, the function corresponding to the commitment scheme; and means for determining whether the candidate sequence has an acceptable relationship with respect to the commitment sequence.

Another example non-transitory, processor-readable storage medium includes processor-readable instructions to cause a processor of a user equipment to: receive a reference signal from a network entity: receive, from the network entity, a commitment sequence corresponding to the reference signal and to a commitment scheme: apply a function to the reference signal to produce a candidate sequence, the function corresponding to the commitment scheme; and determine whether the candidate sequence has an acceptable relationship with respect to the commitment sequence.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example server.

FIG. 7 is a block diagram of a structure of a frequency layer.

FIG. 8 is a communication environment including a user equipment, base stations, and an attacker.

FIG. 9A is an example of downlink positioning reference signal resource sets with four resources, a repetition factor of four, and a time gap of one slot.

FIG. 9B is another example of downlink positioning reference signal resource sets with four resources, a repetition factor of four, and a time gap of four slots.

FIG. 10 is a block diagram of subgroups of a reference signal.

FIG. 11 is a transmission schedule of an example transmission signal.

FIG. 12 is a transmission schedule of another example transmission signal.

FIG. 13 is a transmission schedule of another example transmission signal.

FIG. 14 is a transmission schedule of another example transmission signal.

FIG. 15 is a transmission schedule of another example transmission signal.

FIG. 16 is block diagram of functions performed by a network entity and a user equipment, and signal transfer from the network entity and an attacker to the user equipment.

FIG. 17 is a block flow diagram of a reference signal transmission method.

FIG. 18 is a block flow diagram of a reference signal measurement method.

FIG. 19 is a block flow diagram of a signal transmission method.

FIG. 20 is a block flow diagram of a reference signal verification method.

### DETAILED DESCRIPTION

Techniques are discussed herein for reference signal security. For example, a transmission signal may be transmitted from a network entity to a user equipment, with the transmission signal including both a reference signal and decoding information for decoding the reference signal. Multiple decoding portions may each provide decoding information for different portions of the reference signal. A receiver, e.g., a user equipment, receives the transmission signal, decodes the decoding information, and uses the decoding information to decode the reference signal, and measure the reference signal. The decoding information is provided concurrently with or after the corresponding reference signal portion making it difficult, if not impossible, for a would-be attacker to receive a legitimate reference signal, analyze the legitimate reference signal, and produce and transmit an illegitimate reference signal such that a receiver will use the illegitimate reference signal. Also or alternatively, asymmetric security may be provided for a reference signal transmitted to a receiver. For example, the reference signal and a private key of a transmitter may be used as inputs to a commitment scheme (that may use a one-way function) to produce a verification sequence that is transmitted from the transmitter to the receiver. The transmitter also transmits the reference signal (or a signal corresponding to the reference signal) to the receiver. The receiver receives a reference signal (which may have been transmitted by the transmitter or by an attacker), decodes the reference signal, and uses the reference signal and a public key of the transmitter as inputs to a function to produce a candidate sequence. If the candidate and verification sequences match, then the receiver uses the received reference signal, and otherwise discards the reference signal. Other configurations, however, may be used.

Items and/or techniques described herein may provide one or more of the following capabilities, as well as other capabilities not mentioned. Attacks involving transmission of an illegitimate reference signal that is based on a previously-transmitted reference signal from a legitimate source may be inhibited or prevented from being successful. Attacks involving transmission of an illegitimate reference signal may be inhibited or prevented from being successful by determining that the illegitimate reference signal is not from a trusted source. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrow band Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

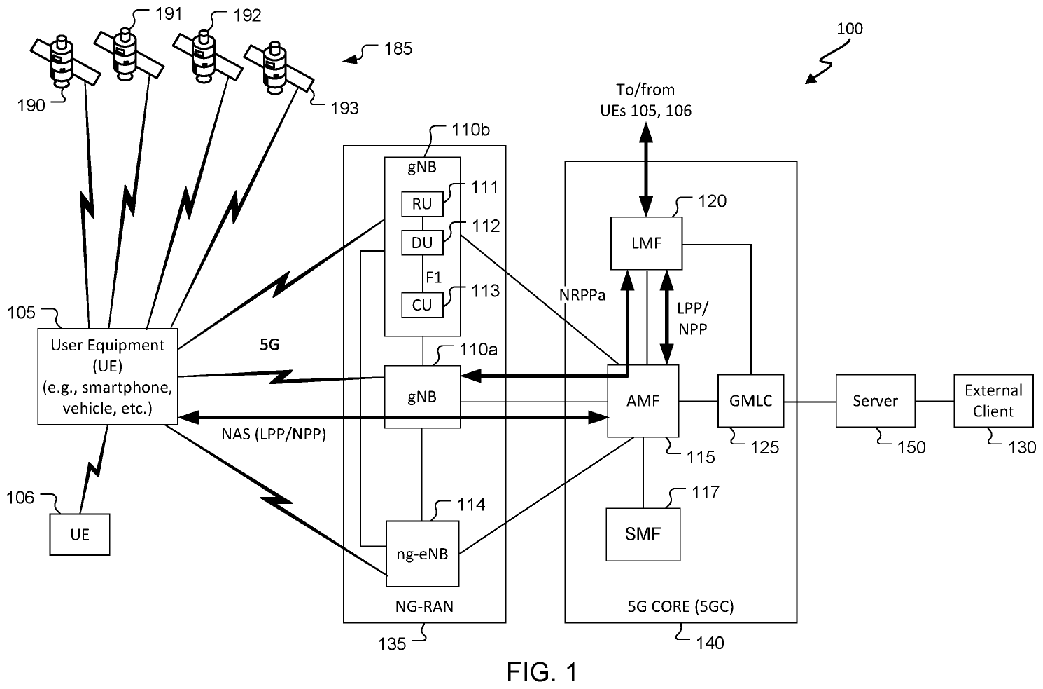

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network: NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a. 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a. 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120) may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QOS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a. 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS (Synchronization Signals) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

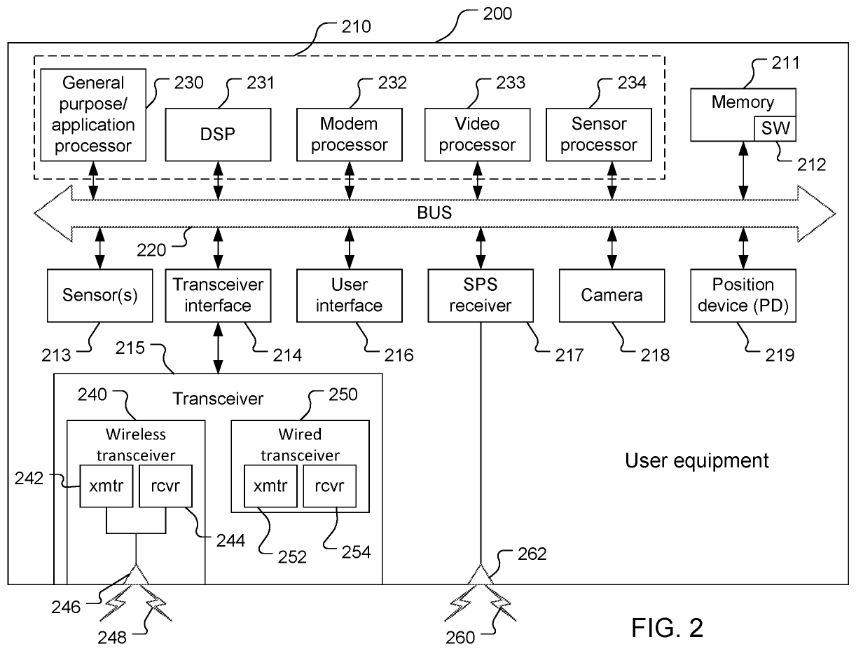

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

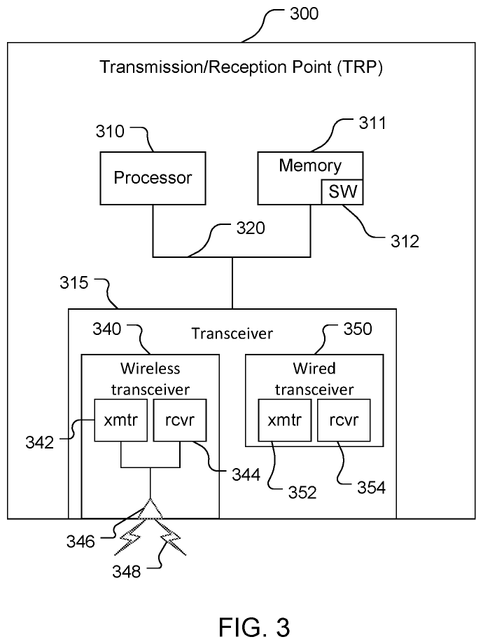

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth® R, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

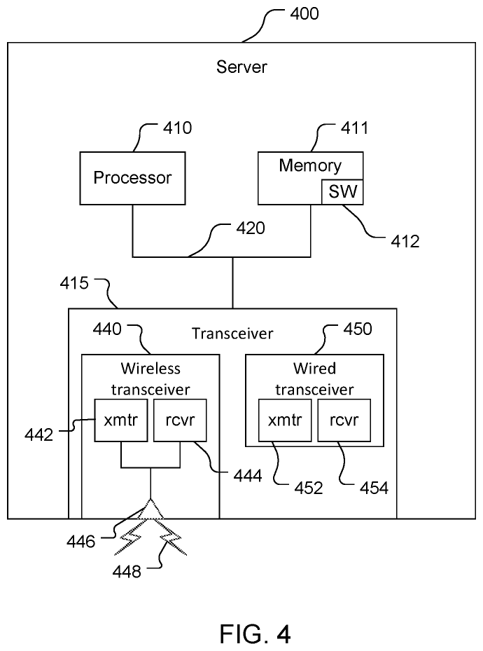

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below:

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records “, one record per cell, where each record contains geographical cell location but also may include other data. An identifier of the” record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AOD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference TRx-Tx (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference TTx-Rx between the transmission time of the RTT measurement signal from the base station and the ToA of the RTT response at the base station to the UE-reported time difference TRx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0) and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

### Security Enhancements for Positioning Applications

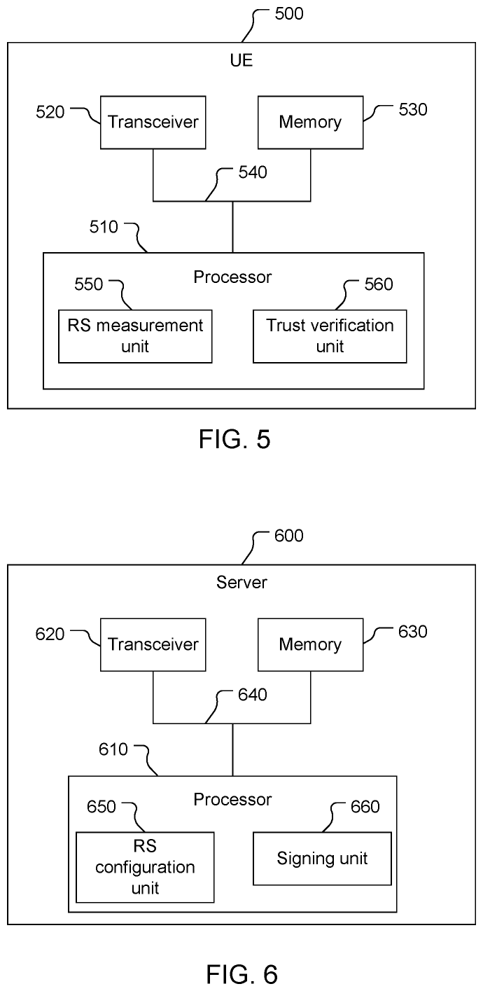

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include an RS measurement unit 550 and/or a trust verification unit 560. The RS measurement unit 550 and the trust verification unit 560 are discussed further below, and the description may refer to the processor 510 generally, or the UE 500 generally, as performing any of the functions of the RS measurement unit 550 or the trust verification unit 560, with the UE 500 being configured to perform the functions of the RS measurement unit 550 and/or the trust verification unit 560. The RS measurement unit 550 may be configured to measure PRS and/or other forms of RS.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include an RS configuration unit 650 (a reference signal configuration unit) and/or a signing unit 660. The RS configuration unit 650 and the signing unit 660 are discussed further below, and the description may refer to the processor 610 generally, or the network entity 600 generally, as performing any of the functions of the RS configuration unit 650 or the signing unit 660, with the network entity 600 being configured to perform the functions of the RS configuration unit 650 and/or the signing unit 660. The RS configuration unit 650 may be configured to determine a configuration of a PRS and/or another form of RS.

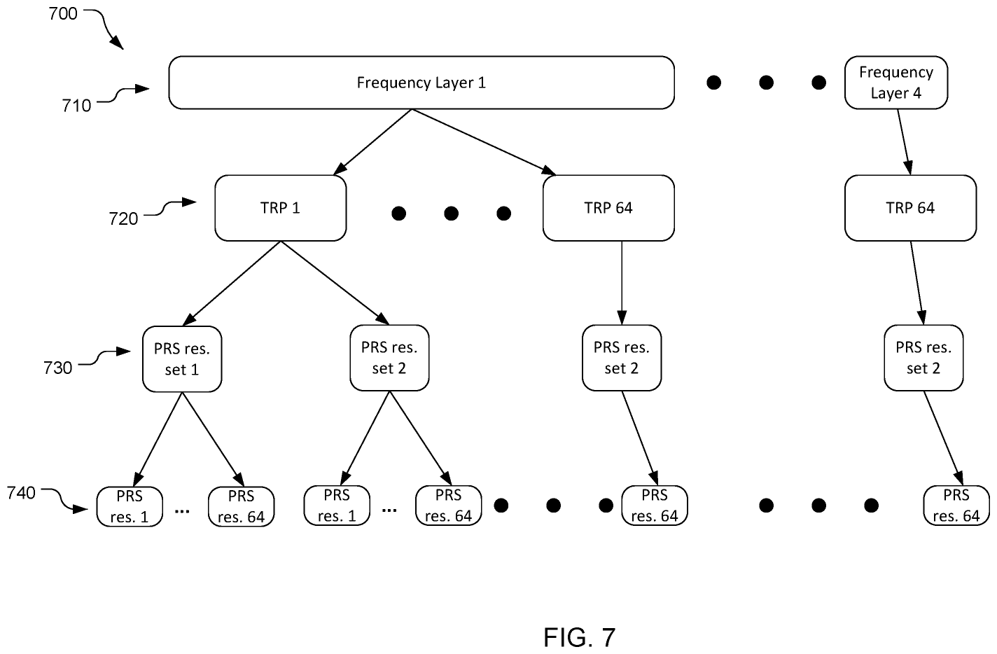

Referring also to FIG. 7, a frequency layer structure 700 includes frequency layers 710, TRPs 720, PRS resource sets 730, and PRS resources 740. A UE may be configured with up to (as in this example) four frequency layers (e.g., DL-PRS PFLs (positioning frequency layers). A DL-PRS PFL is defined as a collection of DL-PRS resource sets that have the following common parameters: the same SCS and CP type, the same value of DL-PRS bandwidth and the same center frequency, and the same comb number. Each frequency layer may have up to 64 TRPs and each TRP may have one or more resource sets, e.g., DL-PRS resource sets. Each resource set includes one or more resources, e.g., DL-PRS resources, each one corresponding to a transmit beam. A DL-PRS resource corresponds to a collection of resource elements arranged in a particular time/frequency pattern (which may be called a schedule or positioning reference signal schedule) inside which pseudo-random QPSK (quadrature phase-shift keying) sequences are transmitted from one antenna port of a TRP. The frequency layer structure 700 includes full complements of four frequency layers, 64 TRPs in each frequency layer, two PRS resource sets for each TRP, and 64 PRS resources in each PRS resource set, but other quantities of frequency layers, TRPs, PRS resource sets, and/or PRS resource may be used, and quantities may be different (e.g., different quantities of PRS resources in different PRS resource sets).

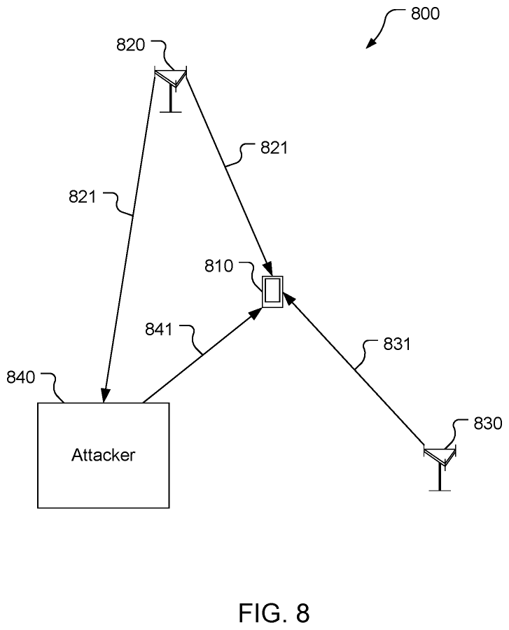

Referring also to FIG. 8, a UE may be susceptible to any of a variety of reference signal attacks that may affect an ability to decode and/or measure a legitimate reference signal, e.g., to measure a positioning reference signal accurately and thus to determine a location of the UE accurately. For example, in an environment 800, a UE 810 may receive legitimate signals 821, 831 from TRPs 820, 830, but may also receive an attack signal 841 from an attacker 840. The attack signal may simulate or copy one of the legitimate signal 821, 831 or may be independent of the legitimate signals 821, 831. For example, in a first type of RS attack, the attacker may receive one or more symbols of the legitimate signal 821, determine transmission parameters (e.g., a scrambling ID (identity)) for the legitimate signal 821, and generate the attack signal 841 using the transmission parameters of the legitimate signal 821. As another example, in a second type of RS attack, the attacker 840 may receive the full configuration of the legitimate signal 821 through broadcast assistance data or a unicast RRC message (e.g., if the attacker 840 is a disguised attacker disposed in the UE 810 (a trojan horse)), and generate the attack signal 841 using the full configuration. If, for example, the legitimate signal 821 is a PRS, and the attack signal simulates the legitimate signal 821, then the UE 810 may measure the attack signal 841 as if the attack signal originated from the location of the TRP 820, which may negatively impact the accuracy of a location of the UE 810 determined using the measurement of the attack signal 841. If different UEs have different signals (e.g., reference signals), then obtaining the signal configuration for one UE will not allow the attacker 840 to attack another UE. If the same signal is used for multiple UEs, then if the attacker compromises one UE and obtains (e.g., receives and/or determines) the signal configuration, then the attacker 840 can use that signal configuration to attack one or more other UEs.

Techniques are discussed herein to try to prevent such attacks from succeeding. For example, knowledge of an RS sequence should not provide useful information for a future RS sequence in order to inhibit the first type of attack. Introduction of pseudo random information may achieve this. As another example, the complete RS configuration information may be withheld until RS transmission, which may inhibit the second type of attack. For example, some or all information for decoding RS resource elements may be sent concurrently with or after transmission of the RS resource elements. A pseudo random sequence may be used that is easily decodable by a receiver (e.g., a UE), and unknown beforehand by an attacker.

Further, due to the scarcity of PRS resources transmitting separate PRS to every receiver (e.g., UE) is not practical, and thus PRS may be multicast or broadcast. The discussion herein focuses on PRS, but the discussion is applicable to other forms of RS or even signals other than RS. To help with transmission to multiple receivers, symmetric encryption may be employed. Symmetric encryption uses a private key to encrypt a message to form an encrypted message, and to decrypt the encrypted message. Symmetric encryption may be used to broadcast PRS to multiple UEs, but an attacker may obtain the private key, which may be widely shared, and use the private key to produce attacks. In asymmetric encryption, the transmitter uses the public key of the receiver to encrypt a message to produce the encrypted message, and the receiver decrypts the encrypted message using the private key of the receiver. The attacker may have more difficulty obtaining the public key of the receiver than the private key in symmetric encryption scenarios, but the asymmetric encryption may not be practical for broadcast of RS.

In a third type of RS attack, the 840 attacker transmits the attack signal 841 without having obtained the configuration of a legitimate signal. For example, the attacker 840 may transmit the attack signal 841 with enough power to obscure one or more of the legitimate signals 821, 831 and/or may transmit an RS configuration and a symmetric key to the receiver, which may decrypt an RS sent using the RS configuration and decode or measure the RS. To help thwart such an attack, an asymmetric encryption technique, as discussed further below, may be used to verify whether a received reference signal is from a legitimate source, e.g., not from an attacker.

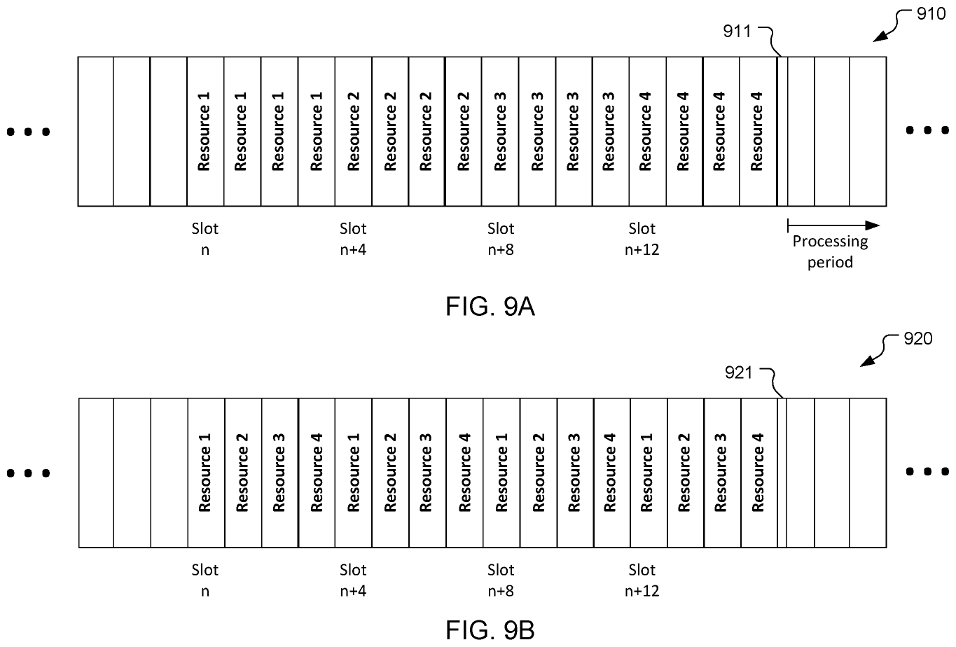

Referring also to FIG. 9A and FIG. 9B, at least some RS configuration may be transmitted after transmission of the RS to help prevent RS attacks and/or to help prevent RS attacks from succeeding. FIG. 9A shows an RS resource set 910 (e.g., a DL-PRS resource set) with four resources, a repetition factor of four, and a time gap of one slot. FIG. 9B shows an RS resource set 920 with four resources, a repetition factor of four, and a time gap of four slots. Hidden information messages 911, 921, that contain some or all of the configuration of the RS transmitted, respectively, may be transmitted after transmission of the RS. Information in the hidden information messages 911, 921 may be called hidden information because this information is kept from (hidden from) the receivers and any attackers until after transmission of the RS that an attack would seek to imitate. The hidden information messages 911, 921 may be encrypted/ciphered MAC-CE (MAC-Control Element) messages. The hidden information messages 911, 921 may be LPP or RRC messages sent by a serving TRP or a server (e.g., an LMF) to the UE. The hidden information messages 911, 921 may be broadcast messages, e.g., group-common PDCCH or a SIB (System Information Block), e.g., a posSIB, that contains, for each periodic RS (e.g., PRS), the hidden information of the RS (e.g., PRS) transmitted before. A processing period for processing the RS (e.g., time to derive RS measurements) may be extended (or started) after the UE 500 has received the hidden information message 911, 921. For example, if the hidden information message 911, 921 is a MAC-CE message, then the starting point could correspond to a threshold number of milliseconds after the slot that carries an ACK/NACK (acknowledge/negative acknowledge). The processing period may be smaller than a typical measurement period since the UE 500 would have already measured the RS. The UE 500 may prioritize RS processing during the time after the RS reception over other physical channels and during a new processing period.

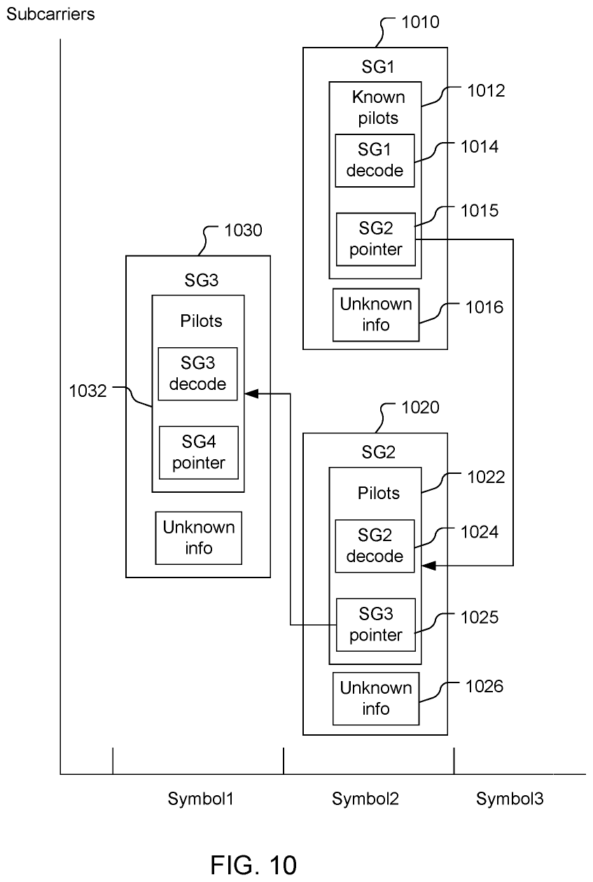

Referring also to FIG. 10, the RS configuration unit 650 is configured to establish an RS configuration with self-dependency between different subgroups of resource elements, where each symbol in the RS configuration has one or more subgroups of resource elements. Dependency between subgroups may be sequential (end to beginning or beginning to end) or pseudo random (e.g., if starting from a last symbol of a PRS, the last sequence subgroup determines an index of the next subgroup (e.g., of one or more symbols)). The dependency may be between symbols and/or within symbols. Known pilots from a PRS subgroup may serve as demodulation pilots providing decoding information to decode unknown information embedded within that PRS subgroup and may provide information for identifying the pilots of another PRS subgroup. For example, within a first subgroup 1010 of a PRS, known pilots 1012 contain decoding information 1014 that the RS measurement unit 550 can use to decode unknown information 1016 of the first subgroup 1010. A pilot is a resource element that carries a modulation symbol known to the transmitter and the receiver. The receiver receives a pilot from which the receiver can estimate a channel, and decode corresponding unknown information. The known pilots 1012 are known in that the RS measurement unit 550) will have sufficient information, independent of the PRS, to find and decode the known pilots 1012. The information to decode the known pilots 1012 (e.g., location of the known pilots 1012 and decoding information for the known pilots 1012) may come from one or more sources, e.g., being statically configured in the UE 500 during manufacture (e.g., as defined in an industry standard) and/or dynamically configured by transmission from the network entity 600 via the transceiver 620 and receipt of the information by the UE 500 via the transceiver 520. For example, the network entity 600 may provide the information to decode the known pilots in response to an explicit request from the UE 500 or an implicit request (e.g., a capability message indicating an ability of the UE 500 to process a transmission signal of reference signal resource elements and decoding resource elements, or a UE ID that maps to such an ability). The known pilots 1012 may further include a pointer 1015 that identifies pilots 1022 of a second subgroup 1020 of the PRS. The pilots 1022 contain decoding information 1024 that the RS measurement unit 550 can use to decode unknown information 1026 of the second subgroup 1020. The pilots 1022 may further include a pointer 1025 that identifies pilots 1032 of a third subgroup 1030 of the PRS. The first subgroup 1010 and the second subgroup 1020 are in a second symbol and the third subgroup 1030 is scheduled in a first symbol. Thus, the dependency of the second subgroup 1020 on the first subgroup 1010 is an example of dependency within a symbol and the dependency of the third subgroup 1030 on the second subgroup 1020 is an example of dependency between symbols.

The RS configuration includes pilots and unknown information. The pilots provide at least one decoding portion of the PRS and the unknown information provides at least one measurement portion of the PRS. In the example shown in FIG. 10, there are three decoding portions and three measurement portions. The RS measurement unit 550 may use the decoding portions to decode the measurement portions and use the measurement portions to determine position information, e.g., make a PRS measurement such time of arrival, and possibly use the PRS measurement to determine further position information (e.g., range to a source, location estimate of the UE 500). The decoding portion(s) that contain information to decode the measurement portion(s) is (are) embedded with the measurement portion(s) and associated with the measurement portion(s) implicitly, such that an explicit indication of the association between the decoding portion(s) and the measurement portion(s) may not be provided. The association is implicit because the decoding portion(s) and the measurement portion(s) are part of a single signal configuration for transmission with the decoding portion(s) scheduled in the same slot as the measurement portion(s) for which the decoding portion(s) provide decoding information. The decoding portion(s) and the measurement portion(s) are transmitted to the UE 500 by the same TRP, e.g., avoiding transmitting the decoding information from a serving TRP and transmitting PRS from a TRP that may not be the serving TRP. Relative amounts of unknown and known information in the PRS (e.g., a ratio of unknown and known information) may result in loss of coverage of the overall PRS. Some of the loss may be recovered by performing multi-step processing, e.g., demodulating then performing timing extraction. Decoding portions and measurement portions may be interlaced between symbols and/or within one or more symbols, which may help improve channel estimation.

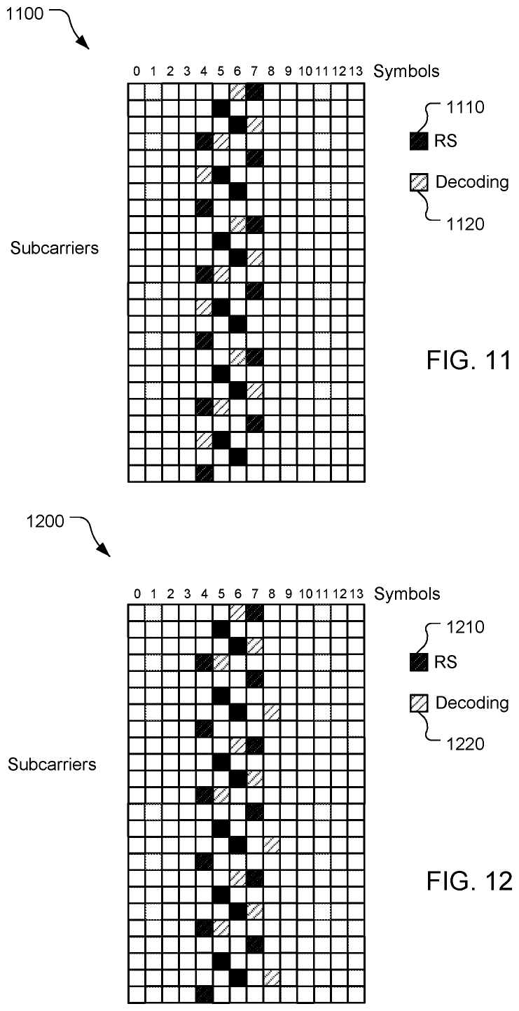

One or more decoding portions may be embedded with one or more measurement portions in any of a variety of configurations. For example, referring also to FIG. 11, a transmission signal 1100, shown in a time/frequency transmission schedule of symbols and subcarriers, comprises measurement portions comprising reference signal resource elements 1110 and decoding portions comprising decoding resource elements 1120. The reference signal resource elements 1110 and the decoding resource elements 1120 are interlaced within each symbol, with each symbol possibly being divided into multiple subgroups of resource elements. In general, an i^{th} symbol, m^{th} subgroup contains the decoding information (e.g., a pilot sequence, which is a bit sequence) for the measurement portion of a k^{th} symbol, n^{th} subgroup in decoding resource elements that are FDMed (Frequency Division Multiplexed) with reference signal resource elements. Various relationships of (k, n) to (i, m) may be used. For example, a sequential relationship may be used with:

$$For n < {N}_{max} :$$

$$k = i \qquad ( 1 )$$

$$m = n + 1 \qquad ( 2 )$$

$$and for n = {N}_{max} :$$

$$k = i - 1 \qquad ( 3 )$$

$$m = 0 \qquad ( 4 )$$

where Nₘₐₓ is the number of subgroups in a symbol. Alternatively, a sequential relationship may be used with equation (3) replaced with

$$k = i + 1 \qquad ( 5 )$$

Alternatively, the relationship of (k, n) to (i, m) may be pseudo random (e.g., random but with constraints such as no two decoding indexes pointing to the same PRS index and/or decoding information being concurrent with or after the PRS). The relationship of (k, n) to (i, m) may yield intra-symbol dependency, e.g., between the subgroups 1010, 1020 and/or inter-symbol dependency, e.g., between the subgroups 1020, 1030. For example, the transmission signal 1100 may have intra-symbol dependency without any inter-symbol dependency, e.g., with the decoding resource elements of each of symbols 4, 5, 6, 7 providing decoding information for the reference signal resource elements 1110 in a same subgroup of the respective symbol 4-7 and pointing to another subgroup, if at all, in the same symbol. With intra-symbol dependency, reference signal resource elements are transmitted concurrently with decoding resource elements containing decoding information for decoding the reference signal resource elements. With inter-symbol dependency, reference signal resource elements are transmitted before decoding resource elements containing decoding information for decoding the reference signal resource elements such that the decoding resource elements are non-causal. As another example, there may be one group of transmission signal resource elements per symbol (instead of multiple subgroups), with the decoding resource elements 1120 of each symbol providing decoding information for the reference signal resource elements in the respective symbol and without pointing to another symbol.

Referring also to FIG. 12, a transmission signal 1200 comprises reference signal resource elements 1210 and decoding resource elements 1220 and includes inter-symbol dependency. In the transmission signal 1200, some of the decoding resource elements 1220 are in symbol 8 without any reference signal resource elements 1210 of the transmission signal 1200 in symbol 8. The decoding resource elements 1220 in symbol 8 provide decoding information and identify reference signal resource elements 1210 of an earlier symbol, e.g., symbol 7. Some of the decoding resource elements 1220 in symbols 5, 6, 7 may provide decoding information for reference signal resource elements 1210 in the same symbol as the decoding resource elements 1220. At least some (and possibly all) of the decoding resource elements 1220 in each of the symbols 5, 6, 7 provide decoding information for, and identify, reference signal resource elements in the symbols 4, 5, 6, respectively. The decoding resource elements 1220 of a symbol (e.g., each of the symbols 6, 7, 8) may point to decoding resource elements 1220 of another symbol (e.g., an immediately-preceding symbol, here symbols 5, 6, 7, respectively). For example, at least some of the decoding resource elements 1220 in symbol 8 may be known, and may point to further decoding resource elements 1220. As another example, at least some of the decoding resource elements 1220 in each symbol may be known, and may point to other decoding resource elements 1220 within the same symbol but without pointing to any decoding resource elements 1220 outside each respective symbol.

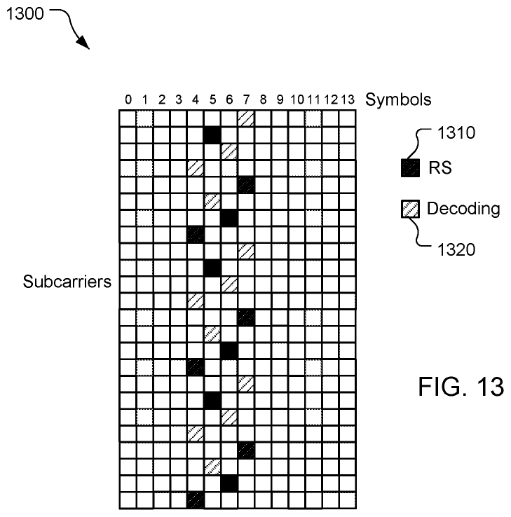

Referring also to FIG. 13, a transmission signal 1300 comprises reference signal resource elements 1310 and decoding resource elements 1320 where the decoding resource elements puncture an RS pattern (e.g., PRS pattern) with decoding information. In this example, the reference signal resource elements 1310 and the decoding resource elements 1320 are interlaced, but instead of adding to the reference signal resource elements 1310 (e.g., PRS resource elements) of a PRS pattern, the decoding resource elements 1320 occupy resource elements of the PRS pattern instead of reference signal resource elements 1310. Conversely, in the transmission signal 1200, the decoding resource elements 1220 supplement the reference signal resource elements 1210, with a reference signal pattern (e.g., a DL-PRS pattern) being preserved and the decoding resource elements 1220 providing the decoding information in between reference signal tones of the reference signal resource elements 1210. The configuration of the transmission signal 1300 keeps an existing reuse pattern between TRPs, and the configuration of the transmission signal 1200 may allow some hardware reuse. In either configuration, the RS configuration unit 650 and the RS measurement unit 550 should know (e.g., through static configuration during manufacture and/or dynamic configuration from received information in accordance with industry standardization) which tones contain decoding information and how the tones are included in the transmission signal, e.g., replacing measurement tones or inserted in addition to measurement tones.

The RS measurement unit 550 of the UE 500 is configured to decode transmission signals containing decoding resource elements and reference signal resource elements, and measure the reference signal resource elements. For example, the RS measurement unit 550 knows the location of, and how to decode, known decoding resource elements, e.g., the known pilots 1012, in a logically first symbol or symbol subgroup, e.g., the first subgroup 1010. The logically first symbol or symbol subgroup may be in the last symbol of the transmission signal. The RS measurement unit 550 will first decode the known decoding resource elements in the logically first symbol or symbol subgroup to determine decoding information, e.g., the decoding information 1014, for decoding corresponding reference signal resource elements, e.g., the unknown information 1016. The decoding resource elements may identify further pilots, e.g., the pilots 1022, and/or further unknown information, e.g., the unknown information 1026, in another symbol or symbol subgroup, and decoding information for decoding the further pilots and/or the further unknown information. The RS measurement unit 550 can then repeat this procedure with the further pilots and further unknown information, e.g., until the transmission signal is fully decoded. The RS measurement unit 550 measures the decoded unknown information, e.g., PRS, to determine one or more measurements, e.g., ToA of PRS. By having the decoding information embedded with the PRS, buffering of the PRS may be avoided, or reduced compared to receiving decoding information after all repetitions of resources are received (e.g., as discussed with respect to FIG. 9A and FIG. 9B).

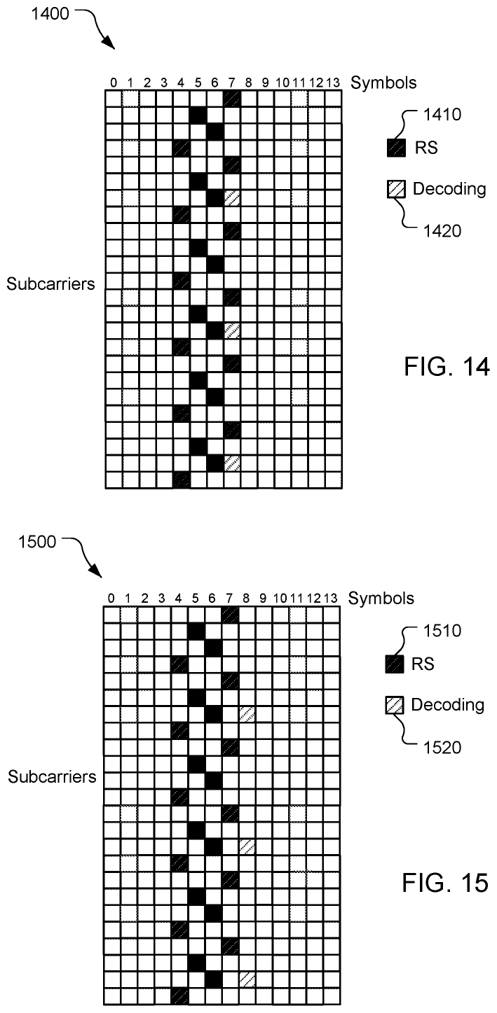

Referring also to FIG. 14 and FIG. 15, transmission signals 1400, 1500 comprise reference signal resource elements 1410, 1510 and decoding resource elements 1420, 1520 where the decoding resource elements 1420, 1520 are disposed in a single symbol, here the last symbols of the transmission signals 1400, 1500, respectively. In the transmission signal 1400, the last symbol, here symbol 7, includes reference signal resource elements 1410 and decoding resource elements 1420. The decoding resource elements 1420 contain decoding information for decoding all of the reference signal resource elements 1410 of the transmission signal 1400, and may contain locations (symbol and subcarrier) of the reference signal resource elements 1410. Some or all of the decoding resource elements 1420 are known resource elements. If less than all of the decoding resource elements 1420 are known resource elements, then the known decoding resource elements will include decoding information for and/or locations of the other decoding resource elements. In the transmission signal 1500, the last symbol, here symbol 8, includes the decoding resource elements 1520 without including any of the reference signal resource elements 1510. The symbol 8 is a data-only symbol (at least with respect to the transmission signal 1500) that is in a later symbol than the symbols containing the reference signal resource elements 1510. Here, the symbol with the decoding resource elements 1520 is immediately after (in the next symbol after) the symbols containing the reference signal resource elements 1510, but other configurations may be used, e.g., with a gap of one or more symbols between the symbols containing the reference signal resource elements 1510 and the symbol containing the decoding resource elements 1520.

The decoding information in the decoding resource elements 1420, 1520 may be used to decode the reference signal resource elements. The RS measurement unit 550 may store the reference signal resource elements 1410, 1510 in the memory 530 (e.g., in a buffer). The RS measurement unit 550 decodes the decoding resource elements 1420, 1520 when the decoding resource elements 1420, 1520 are received to determine decoding information (e.g., location and scrambling ID or other initialization sequence of a secure cypher generator (e.g., the AES-128)) for decoding the reference signal resource elements 1410, 1510. The RS measurement unit 550 uses the decoding information to descramble/process the reference signal resource elements 1410, 1510, e.g., to determine one or more measurements (e.g., time of arrival, received power, etc.). The scrambling ID may be different for different symbols, and the RS measurement unit 550 may determine the scrambling ID for each symbol, use the respective scrambling ID to decode the reference signal resource elements 1410, 1510 of the respective symbol, and use the reference signal resource elements 1410, 1510 that are decoded as additional pilots to determine the measurement(s).

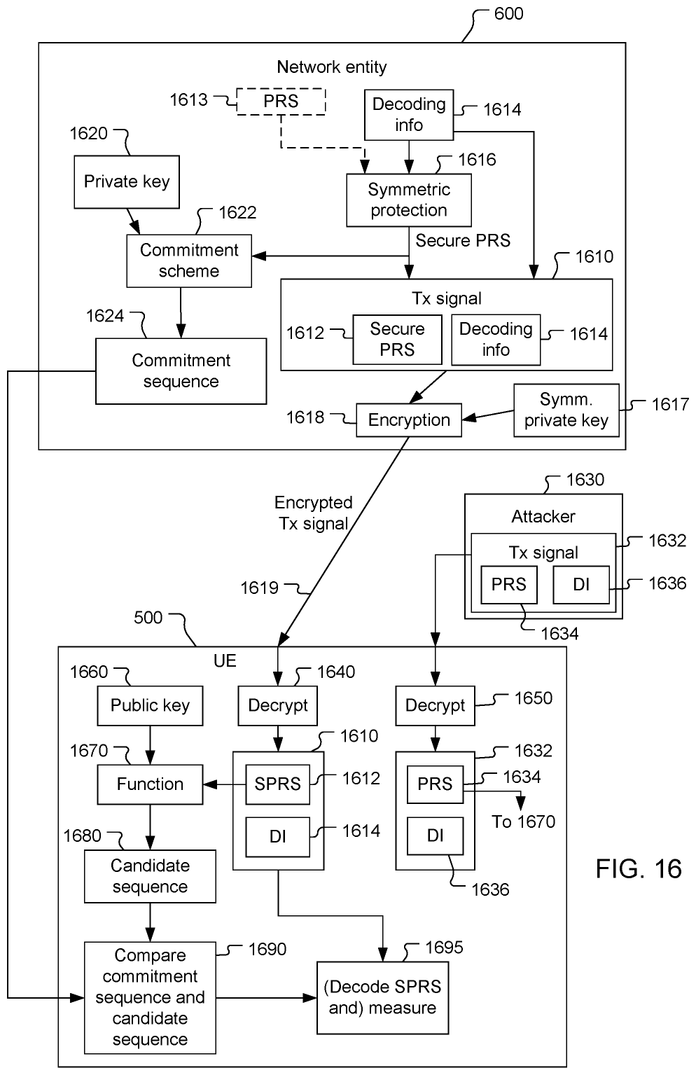

Referring to FIG. 16, with further reference to FIGS. 5 and 6, asymmetric security may be used by the network entity 600 and the UE 500 to help the UE 500 determine that a received signal, e.g., a PRS, is from a trusted source. The signing unit 660 of the network entity 600 uses a signal (in this example, a secure PRS) to be sent in the future and a private cryptographic key of the network entity 600 to produce a commitment sequence, and broadcasts the commitment sequence. The RS measurement unit 550 receives and decrypts a received encrypted transmit signal that includes the secure PRS. The trust verification unit 560 of the UE 500 uses the secure PRS from the RS measurement unit 550, a public cryptographic key of the network entity 600, and the commitment sequence received from the network entity 600 to determine whether the received secure PRS came from a trusted source. An attacker, not knowing the private cryptographic key of the network entity 600, will be highly unlikely, if not completely unable, to generate a PRS and commitment sequence combination that will appear to be from a trusted source. Even if a commitment scheme that does not use a private key of the network entity 600 is used, the commitment scheme will be such that it will be difficult, if not impossible, for the attacker to produce a PRS and commitment sequence combination, or a PRS that in combination with the commitment sequence sent by the network entity 600, will appear to be from a trusted source (even if the network entity 600 sends (e.g., broadcasts) the commitment sequence before sending the PRS). The commitment scheme is so computationally complex that the attacker would not have time to determine the commitment scheme, and produce and send a PRS and commitment sequence to the UE 500 before the UE 500 would receive the trusted PRS and commitment sequence, or to produce a spoofed PRS that would yield the broadcast commitment sequence. The UE 500 may require the commitment sequence and the PRS to be received within a threshold time of each other.

The network entity 600 transmits the secure PRS and the commitment sequence to the UE 500. The RS configuration unit 650 produces a secure PRS 1612, e.g., a sequence of modulation symbols (e.g., QPSK-based modulations) determined based on a sequence of bits. For example, the sequence of bits may be derived using a symmetric protection device 1616, e.g., symmetric secure sequence generator (e.g., the AES-128) initialized with a scrambling ID or a sequence initialization ID. As another example, the secure PRS 1612 may be determined by combining the sequence of bits with a PRS 1613 (determined using a legacy procedure). The RS configuration unit 650 produces a transmission signal 1610 that includes an RS, here the secure PRS 1612 (a DL-PRS), and that may or may not include the decoding information 1614 embedded with the secure PRS 1612 as part of the transmission signal 1610. For example, the transmission signal 1610 may include the decoding information 1614 if the secure PRS 1612 was produced using the PRS 1613 and the sequence of bits produce by the symmetric secure sequence generator. The RS configuration unit 650 encrypts the transmission signal 1610 using a symmetric private cryptographic key 1617 known by the network entity 600 and the UE 500 using an encryption technique 1618 to produce an encrypted transmission signal 1619. The processor 610 transmits, e.g., broadcasts, the encrypted transmission signal 1619 (with symmetric protection, if applied) to the UE 500. The signing unit 660 combines the secure PRS 1612 and an asymmetric private key 1620 in accordance with a commitment scheme 1622 to produce a commitment sequence 1624. For example, the commitment scheme 1622 may be a hash function (e.g., hash function 5667) that yields a shorter bit sequence (e.g., 10 bytes) than the secure PRS 1612, although other commitment schemes are discussed below. The network entity 600 transmits, e.g., broadcasts, the commitment sequence 1624 to the UE 500, e.g., in a SIB or using dedicated messaging.

An attacker 1630 produces and transmits a spoofed transmission signal 1632 that includes a spoofed reference signal, here a spoofed PRS 1634, to the UE 500. The spoofed transmission signal 1632 may include decoding information 1636 (DI 1636) embedded with the spoofed PRS in the spoofed transmission signal 1632. The attacker 1630 may produce the spoofed PRS 1634 using other received PRS or independently of other PRS. The attacker 1630 may encrypt the spoofed transmission signal 1632 (such that the spoofed transmission signal 1632 is an encrypted transmission signal) using a private encryption key that the attacker 1630 provides to the UE 500. The attacker 1630 transmits the spoofed transmission signal 1632 to the UE 500, e.g., with high power, to attempt to have the UE 500 measure the spoofed PRS 1634 and to have the measurement of the spoofed PRS 1634 used to determine position information (e.g., a location estimate) for the UE 500.

The UE 500 may receive and decrypt the secure PRS 1612 and/or the spoofed PRS 1634. The UE 500 may receive the encrypted transmission signal 1619 from the network entity 600 and decrypt 1640 the encrypted transmission signal 1619 using the symmetric private cryptographic key 1617 to determine the secure PRS 1612. The secure PRS 1612 can then be used to verify whether the source of the secure PRS 1612 is authentic. Also or alternatively, the UE 500 may receive the spoofed transmission signal 1632 from the attacker 1630 and decrypt 1650 the spoofed transmission signal 1632 using an encryption key provided to the UE 500 by the attacker 1630 to determine the spoofed PRS 1634 and the decoding information 1636.

The UE 500, e.g., the trust verification unit 560, may use the received PRS (e.g., the secure PRS 1612 or the spoofed PRS 1634) and the received commitment sequence 1624 to determine whether the received PRS is (are) from a trusted source. The trust verification unit 560 uses a public key 1660 of the network entity 600 and the received PRS, e.g., the secure PRS 1612 or the spoofed PRS 1634, in a function 1670 (e.g., a hash function) corresponding to the commitment scheme 1622 to produce a candidate sequence 1680 corresponding to each received PRS. The trust verification unit 560 compares 1690 the received commitment sequence 1624 with the candidate sequence 1680. If the commitment sequence 1624 matches the candidate sequence 1680, then the trust verification unit 560 determines that the corresponding received PRS, e.g., the secure PRS 1612, is from a trusted source and may be used for determining position information for the UE 500. In this case, and if the secure PRS 1612 is based on the PRS 1613, then the RS measurement unit 550 can use the decoding information 1614 to decode the secure PRS 1612 to yield decoded PRS, i.e., the PRS 1613, and measure 1695 the PRS 1613 to determine position information (e.g., ToA). If the secure PRS 1612 is determined to be from a trusted source, and the secure PRS 1612 is the secure sequence of bits (and not based on the PRS 1613), then the RS measurement unit 550 can measure 1695 (without decoding) the secure PRS 1612 as decrypted from the encrypted transmission signal 1619. If the commitment sequence 1624 does not match the candidate sequence 1680, as will occur when the spoofed PRS 1634 is used to determine the candidate sequence 1680, then the trust verification unit 560 determines that the received PRS, e.g., the spoofed PRS 1634, is not from a trusted source and should not be used for determining position information for the UE 500. For example, the trust verification unit 560 may cause the RS measurement unit 550 to disregard the spoofed PRS 1634 and/or to discard any measurement(s) made based on the spoofed PRS 1634.

The network entity 600 should transmit the commitment sequence 1624 close in time to transmission of the transmission signal 1610. The network entity 600 should transmit the commitment sequence 1624 before transmitting the transmission signal 1610. The network entity 600 should transmit the commitment sequence 1624 and the transmission signal 1610 such that there is insufficient time for the attacker to receive the commitment sequence 1624, determine the spoofed PRS 1634 such that the candidate sequence 1680 using the spoofed PRS 1634 will match the commitment sequence 1624, and produce and transmit the spoofed transmission signal 1632 to arrive at the UE 500 before the encrypted transmission signal 1619 or to overwhelm the encrypted transmission signal 1619.

The determination and use of the commitment sequence as discussed is an example, and other examples of determining and using the commitment sequence may be implemented to verify that a received signal is from a trusted source. For example, the public-private key scheme discussed is an example, and other examples (e.g., that do not use the public key 1660) may be implemented (i.e., the public key 1660 may be omitted). In another example implementation, public parameters (p, g, h) may be shared with the UE 500 (and possibly other UEs), e.g., via RRC signaling, where p is a large prime number, g is a number in [2, p-1], and h is an element in [2, p-1] such that log_{g}h is unknown. The network entity 600 may determine the commitment sequence according to

$$Comm . seq . = {g}^{PRS - ID} {h}^{r} mod ( p ) \qquad ( 6 )$$

where PRS-ID determines the PRS sequence and r is a random number. The PRS-ID may be a hash of a PRS index and a timestamp, i.e.,

$$PRS - ID = H ( PRS index \vert timestamp ) \qquad ( 7 )$$

The commitment sequence 1624 may be provided by the network entity 600 to the UE 500 using RRC or NAS (Non-Access Stratum). The network entity 600 sends the PRS, the PRS-ID (or the PRS index and the timestamp), and the random number r to the UE 500, with the PRS index and r possibly being transmitted inside a PRS resource. The UE 500 may verify the commitment sequence after receiving the PRS, the PRS-ID (or the PRS index and the timestamp), and the random number r. As another example implementation, zero-knowledge proof (ZKP) may be leveraged. The network entity 600 has a private key x and a public key y given by

$$y = {g}^{x} mod ( p ) \qquad ( 8 )$$

where g is a public number. The network entity 600 chooses a random number v and computes

$$t = {g}^{v} \qquad ( 9 )$$

$$c = H ( g , y , t , PRS - ID ) \qquad ( 10 )$$

$$r = v - cx \qquad ( 11 )$$

where H ( ) is a cryptographic hash function. The network entity 600 sends the pair (t, r) as the commitment sequence 1624. The UE 500 receives the PRS and decoding information (i.e., the PRS-ID), and calculates c according to Equation (10) given values of g, y, t, and PRS-ID and checks whether the following is true

$$t = {g}^{r} {y}^{c} \qquad ( 12 )$$

This implementation is flexible with secure operations. Each network entity (e.g., gNB) may calculate c while a dedicated function that holds a secret x value computes (t, r). As another example implementation, a simple hash commitment is used with the PRS being hashed with a hash function. As a precondition for this implementation, the UE 500 and the network entity 600 share an authentication key K_{PRS-Auth} (under an assumption that an attacker does not have access to the authentication key K_{PRS-Auth}). The network entity 600 generates a hash of the PRS using the authentication key K_{PRS-Auth}. The network entity 600 transmits (e.g., broadcasts) the hash of the PRS as a commitment value, followed by the PRS. The UE 500 verifies the commitment value after receiving the PRS. A Message Authentication Code (MAC), e.g., a CMAC (Cipher-Based MAC), may be used to authenticate the key. A freshness parameter is used for MAC calculation, e.g., an SFN (System Frame Number) (and slot and/or symbol number) may be used along with an HFN (Hyper Frame Number) (assuming HFN is available for the UE 500). The UE 500 verifies an encryption key K_{PRS-Enc} using the authentication key K_{PRS-Auth}, by checking the MAC. The UE 500 decodes the PRS using the encryption key K_{PRS-Enc}. Still other commitment schemes are possible.

Another example commitment scheme employs a broadcast authentication mechanism. This technique may use a reverse hash chain, with the network entity 600 producing a hash chain of n keys by repeated hashing of a root key according to Equation (13).

$${K}_{i + 1} = Hash ( {K}_{i} ) , wherein 1 \leq i \leq n \qquad ( 13 )$$

The network entity 600 may disclose hash values (keys) in the reverse order of the calculation, i.e., Kₙ at time t₀, Kₙ₋₁ at time t₁, . . . , and K₁ at time tₙ₋₁. The network entity 600 authenticates the initially-reported key, Kₙ, e.g., via a secure RRC signaling during registration or asymmetrical security setup. Each later-disclosed key is verified by the UE 500 using the immediately-preceding key (e.g., immediately-precedingly-disclosed key), i.e., Kₙ₋ᵢ₊₁=Hash (Kₙ₋₁) (e.g., K disclosed at time tᵢ₋₁=Hash (K disclosed at time tᵢ).

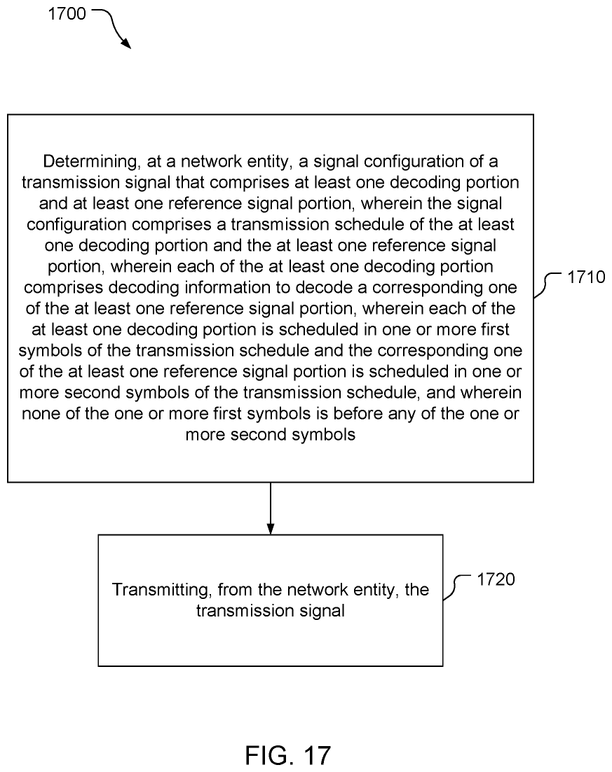

Referring to FIG. 17, with further reference to FIGS. 1-16, a reference signal transmission method 1700 includes the stages shown. The method 1700 is, however, an example and not limiting. The method 1700 may be altered, e.g., by having stages added, removed, rearranged, combined, performed concurrently, and/or having single stages split into multiple stages.

At stage 1710, the method 1700 includes determining, at a network entity, a signal configuration of a transmission signal that comprises at least one decoding portion and at least one reference signal portion, wherein the signal configuration comprises a transmission schedule of the at least one decoding portion and the at least one reference signal portion, wherein each of the at least one decoding portion comprises decoding information to decode a corresponding one of the at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols. For example, the RS configuration unit 650 may determine a transmission signal configuration in response to receiving an explicit or implicit request for scheduling a transmission signal, e.g., a capability message from the UE 500 indicating the ability of the UE 500 to decode a transmission signal including RS REs and decoding REs that include decoding information for decoding the RS REs. The RS configuration unit 650 may determine the transmission signal schedule one or more decoding portions (e.g., decoding resource elements) and one or more corresponding RS portions (e.g., RS resource elements). Each decoding portion may be scheduled to be transmitted with, or after, the RS portion for which the decoding portion includes decoding information. For example, decoding resource elements having decoding information for corresponding RS resource elements will be in the same symbol or one or more later symbols relative to the corresponding RS resource elements. The RS configuration unit 650 may, for example, determine the transmission signal configuration to be like any of transmission schedules for any of the transmission signals 1100, 1200, 1300, 1400, 1500. The processor 610, possibly in combination with the memory 630, may comprise means for determining the signal configuration of the transmission signal.

At stage 1720, the method 1700 includes transmitting, from the network entity, the transmission signal. For example, the RS configuration unit 650 transmits the transmission signal, including an RS and decoding information, e.g., directly or indirectly to the UE 500. The network entity 600 may provide symmetric protection to the transmission signal before transmission. In this way, the likelihood of a successful attack by an attacker that receives a reference signal (e.g., a PRS) and uses information from the received reference signal to send an illegitimate reference signal. The processor 610, possibly in combination with the memory 630, in combination with the transceiver 620 (e.g., the wireless transmitter 342 and the antenna 346) may comprise means for transmitting the transmission signal.

Implementations of the method 1700 may include one or more of the following features. In an example implementation, each symbol of the transmission signal comprises at most one of the at least one decoding portion, or at most one of the at least one reference signal portion, or a combination thereof. For example, the transmission signal configuration may have a single subgroup of resource elements (RS REs and/or decoding REs) per symbol. In a further example implementation, each symbol of the transmission signal comprises a single one of the at least one decoding portion and a single one of the at least one reference signal portion, and wherein for each symbol of the transmission signal, the decoding information of the single one of the at least one decoding portion contains information to decode the single one of the at least one reference signal portion. For example, the decoding REs of each symbol provide decoding information for decoding the RS REs of that same symbol.

Also or alternatively, implementations of the method 1700 may include one or more of the following features. In an example implementation, the at least one reference signal portion and the at least one decoding portion are scheduled in a sequence of subgroups of the transmission schedule, and wherein each of the at least one decoding portion is scheduled in a respective first subgroup of the sequence of subgroups and a corresponding one of the at least one reference signal portion is scheduled in a respective second subgroup of the sequence of subgroups that is immediately prior in the sequence of subgroups to the respective first subgroup of the sequence of subgroups. For example, the decoding portions and reference signal portions may have a sequential relationship as discussed above with respect to Equations (1)-(4). In another example implementation, the at least one decoding portion comprises a first decoding portion and a second decoding portion and the at least one reference signal portion comprises a first reference signal portion and a second reference signal portion, and wherein the first decoding portion identifies the second decoding portion. For example, the decoding portions and reference signal portions may have a pseudo random relationship.

Also or alternatively, implementations of the method 1700 may include one or more of the following features. In an example implementation, the at least one reference signal portion comprises a plurality of reference signal portions and the at least one decoding portion is a single decoding portion for all of the plurality of reference signal portions, and wherein the single decoding portion is scheduled in a last symbol of the transmission signal in the transmission schedule. For example, as shown in FIG. 14 or FIG. 15, the transmission signals 1400, 1500 have decoding information scheduled for the last symbols of the transmission signals 1400, 1500, respectively. In this way, a successful attack using information from a transmitted reference signal is further inhibited by having all or nearly all of the reference signal transmitted before transmission of information needed by an attacker to produce an illegitimate signal. In another example implementation, the at least one reference signal portion comprises a plurality of reference signal portions and the at least one decoding portion is a single decoding portion for all of the plurality of reference signal portions, and wherein the single decoding portion is scheduled after a last symbol of the plurality of reference signal portions of the transmission signal in the transmission schedule. For example, as shown in FIG. 15, the transmission signal 1500 has decoding information scheduled for a symbol after the symbols containing RS REs. In this way, a successful attack using information from a transmitted reference signal is further inhibited by having all of the reference signal transmitted before transmission of information needed by an attacker to produce an illegitimate signal. The symbol with the decoding information could be in the next symbol after the last symbol of RS REs, as shown in FIG. 15, or in a later symbol (with the transmission signal having a gap of one or more symbols between the last RS REs and the decoding REs).

Also or alternatively, implementations of the method 1700 may include one or more of the following features. In an example implementation, the at least one reference signal portion and the at least one decoding portion are scheduled, in combination, in the transmission schedule according to a single comb number. For example, as with the transmission signal 1300, the decoding REs may puncture an RS RE pattern. In this way, a transmission signal with self-dependency may be transmitted while keeping an existing reuse pattern between signal sources (e.g., TRPs). In another example implementation, the at least one reference signal portion is scheduled in the transmission schedule in first resource elements in accordance with a comb number and the at least one decoding portion is scheduled in the transmission schedule in second resource elements that are separate from the first resource elements. For example, as with the transmission signal 1100, decoding REs may be FDMed with RS REs such that an RS structure may be preserved while decoding information is provided between RS tones.

Also or alternatively, implementations of the method 1700 may include one or more of the following features. In an example implementation, the reference signal transmission method further includes: producing a commitment sequence by applying a commitment scheme to the at least one reference signal portion; and transmitting the commitment sequence before transmitting the transmission signal. For example, the signing unit 660 may apply any of a variety of commitment schemes to the secure PRS 1612 to produce the commitment sequence 1624 that the network entity 600 sends to the UE 500. In this way, a successful attack is further inhibited by providing a mechanism for the UE 500 to verify that a received reference signal is from a trusted source. The processor 610, possibly in combination with the memory 630, may comprise means for applying the commitment scheme. The processor 610, possibly in combination with the memory 630, in combination with the transceiver 620 (e.g., the wireless transmitter 342 and the antenna 346) may comprise means for transmitting the commitment sequence. In a further example implementation, the commitment scheme comprises a one-way function, and wherein producing the commitment sequence comprises applying the one-way function to the at least one reference signal portion and a private key of the network entity. For example, the signing unit 660 may hash the asymmetric private key 1620 with the secure PRS 1612 to produce the commitment sequence 1624. In another further example implementation, producing the commitment sequence comprises determining the commitment sequence according to: Comm. seq.=g^{PRS-ID}h^{r}mod(p) where p is a prime number, g is a number in [2, p-1], h is an element in [2, p-1] such that log_{g}h is unknown, PRS-ID corresponds to a positioning reference signal sequence, and r is a random number.

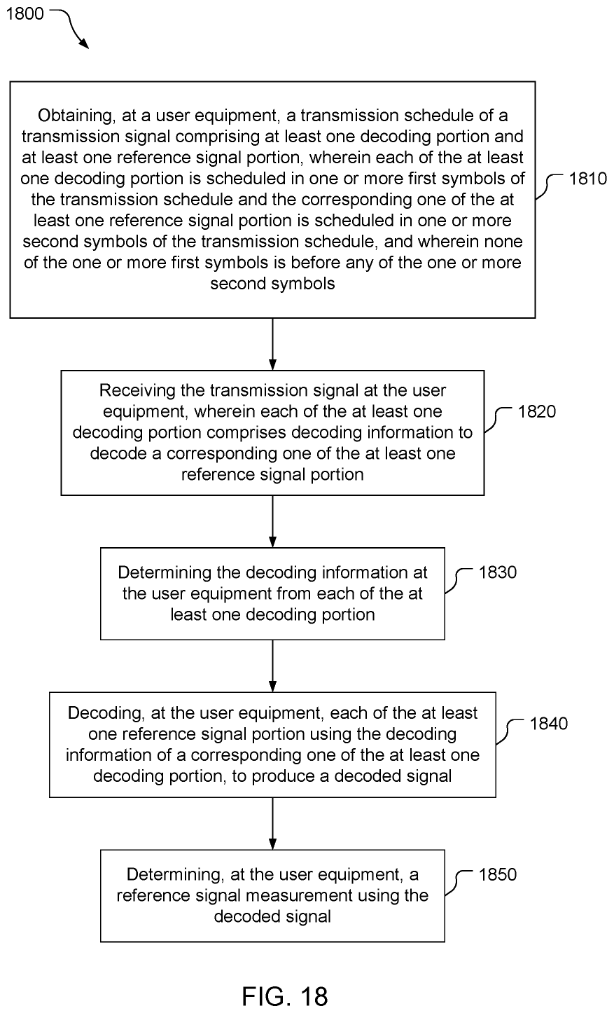

Referring to FIG. 18, with further reference to FIGS. 1-16, a reference signal measurement method 1800 includes the stages shown. The method 1800 is, however, an example and not limiting. The method 1800 may be altered, e.g., by having stages added, removed, rearranged, combined, performed concurrently, and/or having single stages split into multiple stages.

At stage 1810, the method 1800 includes obtaining, at a user equipment, a transmission schedule of a transmission signal comprising at least one decoding portion and at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols. For example, the RS measurement unit 550 may retrieve from the memory 530 and/or receive via the transceiver 520 a transmission schedule of a transmission signal such as any of the transmission signals 1100, 1200, 1300, 1400, 1500 or another transmission signal. The transmission signal includes one or more RS portions and one or more decoding portions, e.g., RS REs and decoding REs that are scheduled simultaneous with or after the respective RS REs, guarding against a successful attack by an attacker trying to receive a legitimate reference signal (from a legitimate source) and use information regarding the received reference signal to transmit an illegitimate reference signal. The processor 510, possibly in combination with the memory 530, possibly in combination with the transceiver 520 (e.g., the wireless receiver 244 and the antenna 246) may comprise means for obtaining the transmission schedule of the transmission signal.

At stage 1820, the method 1800 includes receiving the transmission signal at the user equipment, wherein each of the at least one decoding portion comprises decoding information to decode a corresponding one of the at least one reference signal portion. For example, the RS measurement unit 550 receives the transmission signal including decoding information for decoding the one or more RS portions. The processor 510, possibly in combination with the memory 530, in combination with the transceiver 520 (e.g., the wireless receiver 244 and the antenna 246) may comprise means for receiving the transmission signal.

At stage 1830, the method 1800 includes determining the decoding information at the user equipment from each of the at least one decoding portion. For example, the RS measurement unit 550 decodes known decoding REs at known location(s) and for which the UE 500 knows the decoding information (e.g., the known pilots 1012) to determine decoding information, for decoding RS REs, conveyed by the known decoding REs. If the known decoding REs point to further decoding REs, then the RS measurement unit may decode the further decoding REs and this may continue until there are no more further decoding REs. The processor 510, possibly in combination with the memory 530, may comprise means for determining the decoding information.

At stage 1840, the method 1800 includes decoding, at the user equipment, each of the at least one reference signal portion using the decoding information of a corresponding one of the at least one decoding portion, to produce a decoded signal. For example, the RS measurement unit 550 uses the decoding information of each of the one or more decoding portions (e.g., each containing one or more decoding REs) to decode the respective RS portion of the one or more RS portions (e.g., each containing one or more RS REs) to produce a decoded RS signal, e.g., a PRS. The processor 510, possibly in combination with the memory 530, may comprise means for decoding each of the at least one reference signal portion.

At stage 1850, the method 1800 includes determining, at the user equipment, a reference signal measurement using the decoded signal. For example, the RS measurement unit may determine a time of arrival and/or a power of the decoded signal, which may be used to determine further position information (e.g., a location estimate of the UE 500). The processor 510, possibly in combination with the memory 530, may comprise means for determining the reference signal measurement.

Implementations of the method 1800 may include one or more of the following features. In an example implementation, the at least one decoding portion comprises a first decoding portion and a second decoding portion, and the at least one reference signal portion comprises a first reference signal portion and a second reference signal portion, and wherein the reference signal measurement method further comprises analyzing, at the user equipment, the first decoding portion to identify the second decoding portion. For example, the RS measurement unit 550 may analyze the known pilots 1012 to find the pointer 1015 to identify the pilots 1022. Pointing from one decoding portion to another decoding portion further reduces the likelihood of a successful attack using an illegitimate reference signal based on analyzing a legitimate reference signal. The processor 510, possibly in combination with the memory 530, may comprise means for analyzing the first decoding portion to identify the second decoding portion. In another example implementation, the method 1800 includes storing, at the user equipment, each of the at least one reference signal portion, based on the transmission schedule, until a respective one of the at least one decoding portion is received and the decoding information is determined. For example, the RS measurement unit 550 may buffer RS REs in the memory 530 until corresponding decoding information is received and decoded. The RS measurement unit 550 can use the decoded decoding information to decode the buffered RS REs. This allows for less buffering than if the decoding information is provided after all repetitions of a reference signal resource.

Also or alternatively, implementations of the method 1800 may include one or more of the following features. In an example implementation, the method 1800 includes: receiving, at the user equipment from a network entity, a verification sequence corresponding to the at least one reference signal portion: producing a candidate sequence by applying, at the user equipment, a function to the at least one reference signal portion; and determining, at the user equipment, whether the candidate sequence has an acceptable relationship with respect to the verification sequence. For example, the trust verification unit 560 receives the commitment sequence 1624, applies the secure PRS 1612 to the function 1670 to produce a candidate sequence, and determines whether a relationship of the commitment sequence 1624 and the candidate sequence is acceptable (e.g., indicating that the source of the secure PRS 1612 is a trusted source). This may further prevent successful attacks leading to use of a reference signal (e.g., a PRS) from an untrusted source such as the attacker 1630, which may improve position information accuracy (or at least help prevent position information accuracy degradation due to an attack). In a further example implementation, producing the candidate sequence comprises applying the function to the at least one reference signal portion and a public encryption key of the network entity. For example, the trust verification unit 560 may apply the function to the secure PRS 1612 and to the public key 1660 (e.g., with the secure PRS 1612 and the public key 1660 as inputs to the function 1670) to produce the candidate sequence 1680. In another further example implementation, producing the candidate sequence includes: receiving first parameters p, g, h, and r, where p is a prime number, g is a number in [2, p-1], h is an element in [2, p-1] such that log_{g}h is unknown: receiving a PRS-ID, or second parameters from which the PRS-ID can be determined, or a combination thereof, the PRS-ID corresponding to a positioning reference signal sequence; and determining the candidate sequence according to: Candidate sequence=g^{PRS-ID}h^{r}mod(p).

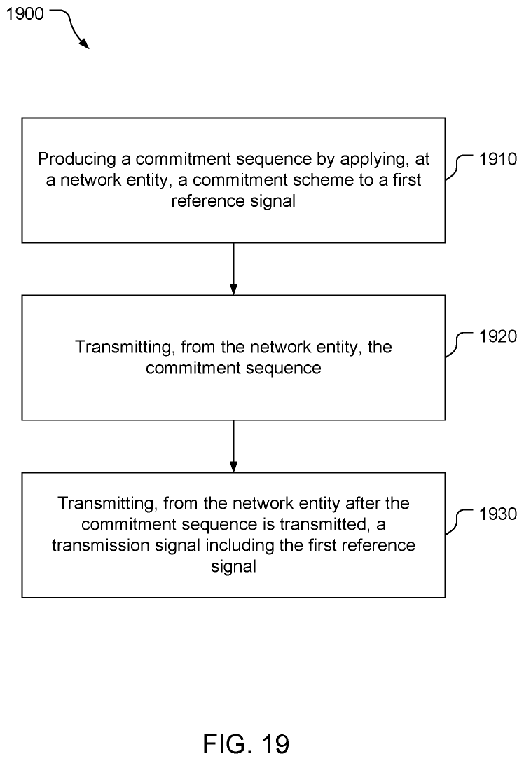

Referring to FIG. 19, with further reference to FIGS. 1-16, a reference signal transmission method 1900 includes the stages shown. The method 1900 is, however, an example and not limiting. The method 1900 may be altered, e.g., by having stages added, removed, rearranged, combined, performed concurrently, and/or having single stages split into multiple stages.

At stage 1910, the method 1900 includes producing a commitment sequence by applying, at a network entity, a commitment scheme to a first reference signal. For example, the signing unit 660 applies the commitment scheme 1622 to the secure PRS 1612 to produce the commitment sequence 1624 (e.g., a reduced-length sequence (e.g., of about 10 bytes) compared to the secure PRS 1612). The processor 610, possibly in combination with the memory 630, may comprise means for producing the commitment scheme.

At stage 1920, the method 1900 includes transmitting, from the network entity, the commitment sequence. For example, the signing unit 660 sends the commitment sequence 1624, e.g., directly or indirectly to the UE 500, e.g., by broadcasting the commitment sequence 1624. The processor 610, possibly in combination with the memory 630, in combination with the transceiver 620 (e.g., the wired transmitter 352 and/or the wireless transmitter 342 and the antenna 346) may comprise means for transmitting the commitment sequence.

At stage 1930, the method 1900 includes transmitting, from the network entity after the commitment sequence is transmitted, a transmission signal including the first reference signal. For example, the RS configuration unit 650 transmits the transmission signal 1610 (and/or the encrypted transmission signal 1619), e.g., directly or indirectly to the UE 500. Transmission of the transmission signal may be initiated after transmission of the commitment sequence is completed or after transmission of the commitment sequence is initiated (even if not completed). The transmission signal 1610 and/or the encrypted transmission signal 1619 may include the decoding information 1614 (e.g., if the PRS 1613 was used to produce the secure PRS 1612) or may not include the decoding information 1614 (e.g., if the PRS 1613 was not used to produce the secure PRS 1612). The processor 610, possibly in combination with the memory 630, in combination with the transceiver 620 (e.g., the wired transmitter 352 and/or the wireless transmitter 342 and the antenna 346) may comprise means for transmitting the transmission signal. Using the method 1900, the likelihood of a successful attack by an attacker transmitting an illegitimate reference signal that would be used by a recipient (e.g., by yielding a candidate sequence that matches the commitment sequence) may be reduced, helping to prevent use of an illegitimate reference signal (e.g., a PRS) from an untrusted source such as the attacker 1630, which may improve position information accuracy (or at least help prevent position information accuracy degradation due to an attack).

Implementations of the method 1900 may include one or more of the following features. In an example implementation, the transmission signal includes a decoding portion, where the transmission signal has a transmission schedule of the first reference signal and the decoding portion, wherein the decoding portion comprises information to decode the first reference signal to produce a second reference signal, where the decoding portion is scheduled in one or more first symbols of the transmission schedule and the first reference signal is scheduled in one or more second symbols of the transmission schedule, and where none of the one or more first symbols is earlier than any of the one or more second symbols. For example, the reference signal transmitted by the RS configuration unit 650 may be part of a transmission signal with both an RS and decoding information embedded, e.g., the transmission signal 1610 including the secure PRS 1612 and the decoding information 1614. This may further help prevent a successful attack based on receiving the first reference signal and using information regarding the first reference signal to produce an illegitimate signal that is sent to the UE 500. In another example implementation, the commitment scheme comprises a one-way function (e.g., a hash function), and producing the commitment scheme comprises applying the one-way function to the first reference signal and to a private key of the network entity. For example, the RS configuration unit 650 may use the secure PRS 1612 and the asymmetric private key 1620 as inputs to the commitment scheme to produce the commitment sequence 1624. In another example implementation, producing the commitment sequence comprises determining the commitment sequence according to: Commitment sequence=g^{PRS-ID}h^{r}mod(p) where p is a prime number, g is a number in [2, p-1], h is an element in [2, p-1] such that log_{g}h is unknown, PRS-ID corresponds to a positioning reference signal sequence, and r is a random number.

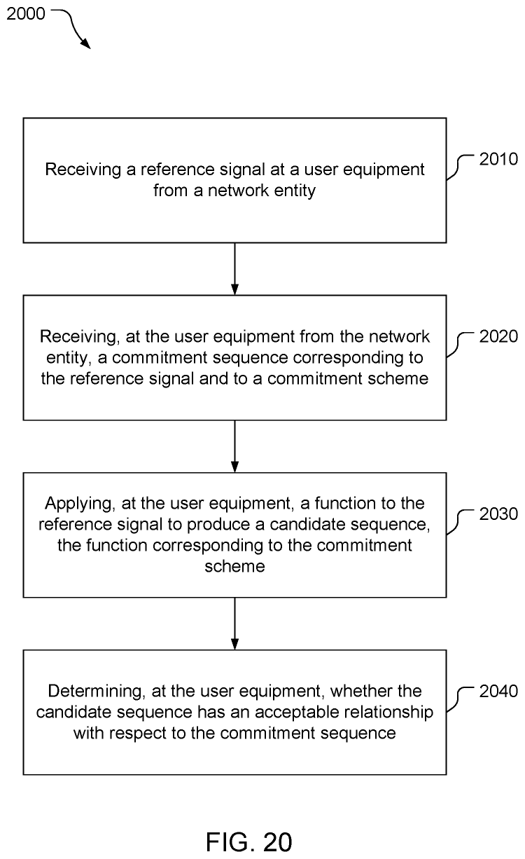

Referring to FIG. 20, with further reference to FIGS. 1-16, a reference signal verification method 2000 includes the stages shown. The method 2000 is, however, an example and not limiting. The method 2000 may be altered, e.g., by having stages added, removed, rearranged, combined, performed concurrently, and/or having single stages split into multiple stages.

At stage 2010, the method 2000 includes receiving a reference signal at a user equipment from a network entity. For example, the RS measurement unit 550 of the UE 500 receives the secure PRS 1612 from the network entity 600. The processor 510, possibly in combination with the memory 530, in combination with the transceiver 520 (e.g., the wireless receiver 244 and the antenna 246) may comprise means for receiving the reference signal.

At stage 2020, the method 2000 includes receiving, at the user equipment from the network entity, a commitment sequence corresponding to the reference signal and to a commitment scheme. For example, the trust verification unit 560 receives the commitment sequence 1624, corresponding to the commitment scheme 1622 and the secure PRS 1612, from the network entity 600. The processor 510, possibly in combination with the memory 530, in combination with the transceiver 520 (e.g., the wireless receiver 244 and the antenna 246) may comprise means for receiving the commitment sequence.

At stage 2030, the method 2000 includes applying, at the user equipment, a function to the reference signal to produce a candidate sequence, the function corresponding to the commitment scheme. For example, the trust verification unit 560 applies the function 1670, that corresponds to the commitment sequence 1624, to the secure PRS 1612 to determine the candidate sequence 1680. Different functions may be applied based on different commitment schemes, e.g., corresponding to different network entities. The processor 510, possibly in combination with the memory 530, may comprise means for applying the function to the reference signal and the public encryption key of the network entity.

At stage 2040, the method 2000 includes determining, at the user equipment, whether the candidate sequence has an acceptable relationship with respect to the commitment sequence. For example, the trust verification unit 560 determines that the source of the PRS is trusted if the commitment sequence 1624 and the candidate sequence 1680 match, and determines that the source of the PRS is not trusted if the commitment sequence 1624 and the candidate sequence 1680 do not match. The method 2000 may thus help prevent an attack that provides an illegitimate reference signal to the UE 500 from being successful by identifying whether a source of a reference signal is trusted or not. The processor 510, possibly in combination with the memory 530, may comprise means for determining whether the candidate sequence has an acceptable relationship with respect to the commitment sequence.

Implementations of the method 2000 may include one or more of the following features. In an example implementation, the method 2000 includes disregarding the reference signal, or a measurement corresponding thereto, in response to determining that the candidate sequence has an unacceptable relationship with respect to the commitment sequence. For example, the RS measurement unit 550 may not measure the reference signal, or may discard a measurement of the reference signal (e.g., the secure PRS 1612 or the PRS 1613), based on the trust verification unit 560 determining that the source of the reference signal is not a trusted source. This may further help prevent an attack with an illegitimate reference signal from succeeding, thus helping ensure good accuracy of reference signal measurement and accuracy of information (e.g., a position estimate for the UE 500) derived from the reference signal measurement. The processor 510, possibly in combination with the memory 530, may comprise means for disregarding the reference signal, or a measurement thereof. In another example implementation, applying the function to produce the candidate sequence further includes applying the function to a public encryption key of the network entity. For example, the trust verification unit 560 uses the secure PRS 1612 and the public key 1660 as inputs to the function 1670 to produce the candidate sequence 1680.

Also or alternatively, implementations of the method 2000 may include one or more of the following features. In an example implementation, the method 2000 includes obtaining, at the user equipment, a transmission schedule of a transmission signal, the transmission signal comprising at least one decoding portion and at least one reference signal portion corresponding to the reference signal, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is earlier than any of the one or more second symbols: receiving, at the user equipment, the transmission signal, wherein each of the at least one decoding portion comprises decoding information to decode a corresponding one of the at least one reference signal portion: determining the decoding information, at the user equipment, from each of the at least one decoding portion: decoding, at the user equipment, each of the at least one reference signal portion, using the decoding information of a corresponding one of the at least one decoding portion, to produce a decoded signal; and determining, at the user equipment, a reference signal measurement using the decoded signal. For example, the RS measurement unit receives (or retrieves from memory) a transmission schedule of a transmission signal with an RS and decoding information, receives the transmission signal, determines the decoding information, uses the decoding information to decode the RS, and determine an RS measurement from the RS. In this way, the likelihood of success is decreased for an attack by an attacker that receives a reference signal, analyzes the reference signal, and transmits an illegitimate signal based on the analysis of the reference signal. The processor 510, possibly in combination with the memory 530, possibly in combination with the transceiver 520 (e.g., the wireless receiver 244 and the antenna 246) may comprise means for obtaining the transmission schedule of the transmission signal. The processor 510, possibly in combination with the memory 530, in combination with the transceiver 520 (e.g., the wireless receiver 244 and the antenna 246) may comprise means for receiving the transmission signal. The processor 510, possibly in combination with the memory 530, may comprise means for determining the decoding information. The processor 510, possibly in combination with the memory 530, may comprise means for decoding each of the at least one reference signal portion. The processor 510, possibly in combination with the memory 530, may comprise means for determining the reference signal measurement.

### Implementation Examples

Implementation examples are provided in the following numbered clauses.

Clause 1. A network entity comprising:
a transceiver;
a memory; and
a processor, communicatively coupled to the memory and the transceiver, configured to:
   determine a signal configuration of a transmission signal that comprises at least one decoding portion and at least one reference signal portion, wherein the signal configuration comprises a transmission schedule of the at least one decoding portion and the at least one reference signal portion, wherein each of the at least one decoding portion comprises decoding information to decode a corresponding one of the at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols; and
   transmit, via the transceiver, the transmission signal.

Clause 2. The network entity of clause 1, wherein each symbol of the transmission signal comprises at most one of the at least one decoding portion, or at most one of the at least one reference signal portion, or a combination thereof.

Clause 3. The network entity of clause 2, wherein each symbol of the transmission signal comprises a single one of the at least one decoding portion and a single one of the at least one reference signal portion, and wherein for each symbol of the transmission signal, the decoding information of the single one of the at least one decoding portion contains information to decode the single one of the at least one reference signal portion.

Clause 4. The network entity of clause 1, wherein the at least one reference signal portion and the at least one decoding portion are scheduled in a sequence of subgroups of the transmission schedule, and wherein each of the at least one decoding portion is scheduled in a respective first subgroup of the sequence of subgroups and a corresponding one of the at least one reference signal portion is scheduled in a respective second subgroup of the sequence of subgroups that is immediately prior in the sequence of subgroups to the respective first subgroup of the sequence of subgroups.

Clause 5. The network entity of clause 1, wherein the at least one decoding portion comprises a first decoding portion and a second decoding portion and the at least one reference signal portion comprises a first reference signal portion and a second reference signal portion, and wherein the first decoding portion identifies the second decoding portion.

Clause 6. The network entity of clause 1, wherein the at least one reference signal portion comprises a plurality of reference signal portions and the at least one decoding portion is a single decoding portion for all of the plurality of reference signal portions, and wherein the single decoding portion is scheduled in a last symbol of the transmission signal in the transmission schedule.

Clause 7. The network entity of clause 1, wherein the at least one reference signal portion comprises a plurality of reference signal portions and the at least one decoding portion is a single decoding portion for all of the plurality of reference signal portions, and wherein the single decoding portion is scheduled after a last symbol of the plurality of reference signal portions of the transmission signal in the transmission schedule.

Clause 8. The network entity of clause 1, wherein the at least one reference signal portion and the at least one decoding portion are scheduled, in combination, in the transmission schedule according to a single comb number.

Clause 9. The network entity of clause 1, wherein the at least one reference signal portion is scheduled in the transmission schedule in first resource elements in accordance with a comb number and the at least one decoding portion is scheduled in the transmission schedule in second resource elements that are separate from the first resource elements.

Clause 10. The network entity of clause 1, wherein the processor is further configured to:
produce a commitment sequence by applying a commitment scheme to the at least one reference signal portion; and transmit, via the transceiver, the commitment sequence before transmitting the transmission signal.

Clause 11. The network entity of clause 10, wherein the commitment scheme comprises a one-way function, and wherein to produce the commitment sequence the processor is further configured to apply the one-way function to the at least one reference signal portion and a private key of the network entity.

Clause 12. The network entity of clause 10, wherein to produce the commitment sequence the processor is further configured to determine the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 13. A reference signal transmission method comprising:
determining, at a network entity, a signal configuration of a transmission signal that comprises at least one decoding portion and at least one reference signal portion, wherein the signal configuration comprises a transmission schedule of the at least one decoding portion and the at least one reference signal portion, wherein each of the at least one decoding portion comprises decoding information to decode a corresponding one of the at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols; and transmitting, from the network entity, the transmission signal.

Clause 14. The reference signal transmission method of clause 13, wherein each symbol of the transmission signal comprises at most one of the at least one decoding portion, or at most one of the at least one reference signal portion, or a combination thereof.

Clause 15. The reference signal transmission method of clause 14, wherein each symbol of the transmission signal comprises a single one of the at least one decoding portion and a single one of the at least one reference signal portion, and wherein for each symbol of the transmission signal, the decoding information of the single one of the at least one decoding portion contains information to decode the single one of the at least one reference signal portion.

Clause 16. The reference signal transmission method of clause 13, wherein the at least one reference signal portion and the at least one decoding portion are scheduled in a sequence of subgroups of the transmission schedule, and wherein each of the at least one decoding portion is scheduled in a respective first subgroup of the sequence of subgroups and a corresponding one of the at least one reference signal portion is scheduled in a respective second subgroup of the sequence of subgroups that is immediately prior in the sequence of subgroups to the respective first subgroup of the sequence of subgroups.

Clause 17. The reference signal transmission method of clause 13, wherein the at least one decoding portion comprises a first decoding portion and a second decoding portion and the at least one reference signal portion comprises a first reference signal portion and a second reference signal portion, and wherein the first decoding portion identifies the second decoding portion.

Clause 18. The reference signal transmission method of clause 13, wherein the at least one reference signal portion comprises a plurality of reference signal portions and the at least one decoding portion is a single decoding portion for all of the plurality of reference signal portions, and wherein the single decoding portion is scheduled in a last symbol of the transmission signal in the transmission schedule.

Clause 19. The reference signal transmission method of clause 13, wherein the at least one reference signal portion comprises a plurality of reference signal portions and the at least one decoding portion is a single decoding portion for all of the plurality of reference signal portions, and wherein the single decoding portion is scheduled after a last symbol of the plurality of reference signal portions of the transmission signal in the transmission schedule.

Clause 20. The reference signal transmission method of clause 13, wherein the at least one reference signal portion and the at least one decoding portion are scheduled, in combination, in the transmission schedule according to a single comb number.

Clause 21. The reference signal transmission method of clause 13, wherein the at least one reference signal portion is scheduled in the transmission schedule in first resource elements in accordance with a comb number and the at least one decoding portion is scheduled in the transmission schedule in second resource elements that are separate from the first resource elements.

Clause 22. The reference signal transmission method of clause 13, further comprising:
producing a commitment sequence by applying a commitment scheme to the at least one reference signal portion; and
transmitting the commitment sequence before transmitting the transmission signal.

Clause 23. The reference signal transmission method of clause 22, wherein the commitment scheme comprises a one-way function, and wherein producing the commitment sequence comprises applying the one-way function to the at least one reference signal portion and a private key of the network entity.

Clause 24. The reference signal transmission method of clause 22, wherein producing the commitment sequence comprises determining the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 25. A network entity comprising:
means for determining a signal configuration of a transmission signal that comprises at least one decoding portion and at least one reference signal portion, wherein the signal configuration comprises a transmission schedule of the at least one decoding portion and the at least one reference signal portion, wherein each of the at least one decoding portion comprises decoding information to decode a corresponding one of the at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols; and
means for transmitting the transmission signal.

Clause 26. The network entity of clause 25, wherein each symbol of the transmission signal comprises at most one of the at least one decoding portion, or at most one of the at least one reference signal portion, or a combination thereof.

Clause 27. The network entity of clause 26, wherein each symbol of the transmission signal comprises a single one of the at least one decoding portion and a single one of the at least one reference signal portion, and wherein for each symbol of the transmission signal, the decoding information of the single one of the at least one decoding portion contains information to decode the single one of the at least one reference signal portion.

Clause 28. The network entity of clause 25, wherein the at least one reference signal portion and the at least one decoding portion are scheduled in a sequence of subgroups of the transmission schedule, and wherein each of the at least one decoding portion is scheduled in a respective first subgroup of the sequence of subgroups and a corresponding one of the at least one reference signal portion is scheduled in a respective second subgroup of the sequence of subgroups that is immediately prior in the sequence of subgroups to the respective first subgroup of the sequence of subgroups.

Clause 29. The network entity of clause 25, wherein the at least one decoding portion comprises a first decoding portion and a second decoding portion and the at least one reference signal portion comprises a first reference signal portion and a second reference signal portion, and wherein the first decoding portion identifies the second decoding portion.

Clause 30. The network entity of clause 25, wherein the at least one reference signal portion comprises a plurality of reference signal portions and the at least one decoding portion is a single decoding portion for all of the plurality of reference signal portions, and wherein the single decoding portion is scheduled in a last symbol of the transmission signal in the transmission schedule.

Clause 31. The network entity of clause 25, wherein the at least one reference signal portion comprises a plurality of reference signal portions and the at least one decoding portion is a single decoding portion for all of the plurality of reference signal portions, and wherein the single decoding portion is scheduled after a last symbol of the plurality of reference signal portions of the transmission signal in the transmission schedule.

Clause 32. The network entity of clause 25, wherein the at least one reference signal portion and the at least one decoding portion are scheduled, in combination, in the transmission schedule according to a single comb number.

Clause 33. The network entity of clause 25, wherein the at least one reference signal portion is scheduled in the transmission schedule in first resource elements in accordance with a comb number and the at least one decoding portion is scheduled in the transmission schedule in second resource elements that are separate from the first resource elements.

Clause 34. The network entity of clause 25, further comprising:
means for producing a commitment sequence by applying a commitment scheme to the at least one reference signal portion; and
means for transmitting the commitment sequence before transmitting the transmission signal.

Clause 35. The network entity of clause 34, wherein the commitment scheme comprises a one-way function, and wherein the means for producing the commitment sequence comprise means for applying the one-way function to the at least one reference signal portion and a private key of the network entity.

Clause 36. The network entity of clause 34, wherein the means for producing the commitment sequence comprise means for determining the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 37. A non-transitory, processor-readable storage medium comprising processor-readable instructions to cause a processor of a network entity to:
determine a signal configuration of a transmission signal that comprises at least one decoding portion and at least one reference signal portion, wherein the signal configuration comprises a transmission schedule of the at least one decoding portion and the at least one reference signal portion, wherein each of the at least one decoding portion comprises decoding information to decode a corresponding one of the at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols; and
transmit the transmission signal.

Clause 38. The non-transitory, processor-readable storage medium of clause 37, wherein each symbol of the transmission signal comprises at most one of the at least one decoding portion, or at most one of the at least one reference signal portion, or a combination thereof.

Clause 39. The non-transitory, processor-readable storage medium of clause 38, wherein each symbol of the transmission signal comprises a single one of the at least one decoding portion and a single one of the at least one reference signal portion, and wherein for each symbol of the transmission signal, the decoding information of the single one of the at least one decoding portion contains information to decode the single one of the at least one reference signal portion.

Clause 40. The non-transitory, processor-readable storage medium of clause 37, wherein the at least one reference signal portion and the at least one decoding portion are scheduled in a sequence of subgroups of the transmission schedule, and wherein each of the at least one decoding portion is scheduled in a respective first subgroup of the sequence of subgroups and a corresponding one of the at least one reference signal portion is scheduled in a respective second subgroup of the sequence of subgroups that is immediately prior in the sequence of subgroups to the respective first subgroup of the sequence of subgroups.

Clause 41. The non-transitory, processor-readable storage medium of clause 37, wherein the at least one decoding portion comprises a first decoding portion and a second decoding portion and the at least one reference signal portion comprises a first reference signal portion and a second reference signal portion, and wherein the first decoding portion identifies the second decoding portion.

Clause 42. The non-transitory, processor-readable storage medium of clause 37, wherein the at least one reference signal portion comprises a plurality of reference signal portions and the at least one decoding portion is a single decoding portion for all of the plurality of reference signal portions, and wherein the single decoding portion is scheduled in a last symbol of the transmission signal in the transmission schedule.

Clause 43. The non-transitory, processor-readable storage medium of clause 37, wherein the at least one reference signal portion comprises a plurality of reference signal portions and the at least one decoding portion is a single decoding portion for all of the plurality of reference signal portions, and wherein the single decoding portion is scheduled after a last symbol of the plurality of reference signal portions of the transmission signal in the transmission schedule.

Clause 44. The non-transitory, processor-readable storage medium of clause 37, wherein the at least one reference signal portion and the at least one decoding portion are scheduled, in combination, in the transmission schedule according to a single comb number.

Clause 45. The non-transitory, processor-readable storage medium of clause 37, wherein the at least one reference signal portion is scheduled in the transmission schedule in first resource elements in accordance with a comb number and the at least one decoding portion is scheduled in the transmission schedule in second resource elements that are separate from the first resource elements.

Clause 46. The non-transitory, processor-readable storage medium of clause 37, further comprising processor-readable instructions to cause the processor to:
produce a commitment sequence by applying a commitment scheme to the at least one reference signal portion; and
transmit the commitment sequence before transmitting the transmission signal.

Clause 47. The non-transitory, processor-readable storage medium of clause 46, wherein the commitment scheme comprises a one-way function, and wherein the processor-readable instructions to cause the processor to produce the commitment sequence comprise processor-readable instructions to cause the processor to apply the one-way function to the at least one reference signal portion and a private key of the network entity.

Clause 48. The non-transitory, processor-readable storage medium of clause 46, wherein the processor-readable instructions to cause the processor to produce the commitment sequence comprise processor-readable instructions to cause the processor to determine the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 49. A user equipment comprising:
a transceiver:
a memory; and a processor, communicatively coupled to the memory and the transceiver, configured to:
obtain a transmission schedule of a transmission signal comprising at least one decoding portion and at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols:
receive, via the transceiver, the transmission signal, wherein each of the at least one decoding portion comprises decoding information to decode a corresponding one of the at least one reference signal portion;
determine, from each of the at least one decoding portion, the decoding information:
decode each of the at least one reference signal portion using the decoding information of a corresponding one of the at least one decoding portion, to produce a decoded signal; and determine a reference signal measurement using the decoded signal.

Clause 50. The user equipment of clause 49, wherein the at least one decoding portion comprises a first decoding portion and a second decoding portion, and the at least one reference signal portion comprises a first reference signal portion and a second reference signal portion, and wherein the processor is configured to analyze the first decoding portion to identify the second decoding portion.

Clause 51. The user equipment of clause 49, wherein the processor is configured to store each of the at least one reference signal portion, based on the transmission schedule, until the processor receives a respective one of the at least one decoding portion and determines the decoding information.

Clause 52. The user equipment of clause 49, wherein the processor is further configured to:
receive, via the transceiver from a network entity, a verification sequence corresponding to the at least one reference signal portion;
produce a candidate sequence by applying a function to the at least one reference signal portion; and
determine whether the candidate sequence has an acceptable relationship with respect to the verification sequence.

Clause 53. The user equipment of clause 52, wherein to produce the candidate sequence the processor is further configured to apply the function to the at least one reference signal portion and a public encryption key of the network entity.

Clause 54. The user equipment of clause 52, wherein to produce the candidate sequence the processor is further configured to:
receive, via the transceiver, first parameters p, g, h, and r, where p is a prime number, g is a number in [2, p-1], h is an element in [2, p-1] such that log_{g}h is unknown;
receive, via the transceiver, a PRS-ID, or second parameters from which the PRS-ID can be determined, or a combination thereof, the PRS-ID corresponding to a positioning reference signal sequence; and
determine the candidate sequence according to:

Candidate sequence=g^{PRS-ID}h^{r}mod(p).

Clause 55. A reference signal measurement method comprising:
obtaining, at a user equipment, a transmission schedule of a transmission signal comprising at least one decoding portion and at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols;
receiving the transmission signal at the user equipment, wherein each of the at least one decoding portion comprises decoding information to decode a corresponding one of the at least one reference signal portion;
determining the decoding information at the user equipment from each of the at least one decoding portion;
decoding, at the user equipment, each of the at least one reference signal portion using the decoding information of a corresponding one of the at least one decoding portion, to produce a decoded signal; and
determining, at the user equipment, a reference signal measurement using the decoded signal.

Clause 56. The reference signal measurement method of clause 55, wherein the at least one decoding portion comprises a first decoding portion and a second decoding portion, and the at least one reference signal portion comprises a first reference signal portion and a second reference signal portion, and wherein the reference signal measurement method further comprises analyzing, at the user equipment, the first decoding portion to identify the second decoding portion.

Clause 57. The reference signal measurement method of clause 55, further comprising storing, at the user equipment, each of the at least one reference signal portion, based on the transmission schedule, until a respective one of the at least one decoding portion is received and the decoding information is determined.

Clause 58. The reference signal measurement method of clause 55, further comprising:
receiving, at the user equipment from a network entity, a verification sequence corresponding to the at least one reference signal portion;
producing a candidate sequence by applying, at the user equipment, a function to the at least one reference signal portion; and
determining, at the user equipment, whether the candidate sequence has an acceptable relationship with respect to the verification sequence.

Clause 59. The reference signal measurement method of clause 58, wherein producing the candidate sequence comprises applying the function to the at least one reference signal portion and a public encryption key of the network entity.

Clause 60. The reference signal measurement method of clause 58, wherein producing the candidate sequence comprises:
receiving first parameters p, g, h, and r, where p is a prime number, g is a number in [2, p-1], h is an element in [2, p-1] such that log_{g}h is unknown;
receiving a PRS-ID, or second parameters from which the PRS-ID can be determined, or a combination thereof, the PRS-ID corresponding to a positioning reference signal sequence; and
determining the candidate sequence according to:

Candidate sequence=g^{PRS-ID}h^{r}mod(p).

Clause 61. A user equipment comprising:
means for obtaining a transmission schedule of a transmission signal comprising at least one decoding portion and at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols;
means for receiving the transmission signal, wherein each of the at least one decoding portion comprises decoding information to decode a corresponding one of the at least one reference signal portion;
means for determining the decoding information from each of the at least one decoding portion;
means for decoding each of the at least one reference signal portion using the decoding information of a corresponding one of the at least one decoding portion, to produce a decoded signal; and
means for determining a reference signal measurement using the decoded signal.

Clause 62. The user equipment of clause 61, wherein the at least one decoding portion comprises a first decoding portion and a second decoding portion, and the at least one reference signal portion comprises a first reference signal portion and a second reference signal portion, and wherein the user equipment further comprises means for analyzing the first decoding portion to identify the second decoding portion.

Clause 63. The user equipment of clause 61, further comprising means for storing each of the at least one reference signal portion, based on the transmission schedule, until a respective one of the at least one decoding portion is received and the decoding information is determined.

Clause 64. The user equipment of clause 61, further comprising:
means for receiving, from a network entity, a verification sequence corresponding to the at least one reference signal portion;
means for producing a candidate sequence by applying a function to the at least one reference signal portion; and
means for determining whether the candidate sequence has an acceptable relationship with respect to the verification sequence.

Clause 65. The user equipment of clause 64, wherein the means for producing the candidate sequence comprise means for applying the function to the at least one reference signal portion and a public encryption key of the network entity.

Clause 66. The user equipment of clause 64, wherein the means for producing the candidate sequence comprise:
means for receiving first parameters p, g, h, and r, where p is a prime number, g is a number in [2, p-1], h is an element in [2, p-1] such that log_{g}h is unknown;
means for receiving a PRS-ID, or second parameters from which the PRS-ID can be determined, or a combination thereof, the PRS-ID corresponding to a positioning reference signal sequence; and
means for determining the candidate sequence according to:

Candidate sequence=g^{PRS-ID}h^{r}mod(p).

Clause 67. A non-transitory, processor-readable storage medium comprising processor-readable instructions to cause a processor of a user equipment to:
obtain a transmission schedule of a transmission signal comprising at least one decoding portion and at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols;
receive the transmission signal, wherein each of the at least one decoding portion comprises decoding information to decode a corresponding one of the at least one reference signal portion;
determine the decoding information from each of the at least one decoding portion;
decode each of the at least one reference signal portion using the decoding information of a corresponding one of the at least one decoding portion, to produce a decoded signal; and
determine a reference signal measurement using the decoded signal.

Clause 68. The non-transitory, processor-readable storage medium of clause 67, wherein the at least one decoding portion comprises a first decoding portion and a second decoding portion, and the at least one reference signal portion comprises a first reference signal portion and a second reference signal portion, and wherein the non-transitory, processor-readable storage medium further comprises processor-readable instructions to cause the processor to analyze the first decoding portion to identify the second decoding portion.

Clause 69. The non-transitory, processor-readable storage medium of clause 67, further comprising processor-readable instructions to cause the processor to store each of the at least one reference signal portion, based on the transmission schedule, until a respective one of the at least one decoding portion is received and the decoding information is determined.

Clause 70. The non-transitory, processor-readable storage medium of clause 67, further comprising processor-readable instructions to cause the processor to:
receive, from a network entity, a verification sequence corresponding to the at least one reference signal portion;
produce a candidate sequence by applying a function to the at least one reference signal portion; and
determine whether the candidate sequence has an acceptable relationship with respect to the verification sequence.

Clause 71. The non-transitory, processor-readable storage medium of clause 70, wherein the processor-readable instructions to cause the processor to produce the candidate sequence comprise processor-readable instructions to cause the processor to apply the function to the at least one reference signal portion and a public encryption key of the network entity.

Clause 72. The non-transitory, processor-readable storage medium of clause 70, wherein the processor-readable instructions to cause the processor to produce the candidate sequence comprise processor-readable instructions to cause the processor to:
receive first parameters p, g, h, and r, where p is a prime number, g is a number in [2, p-1], h is an element in [2, p-1] such that log_{g}h is unknown;
receive a PRS-ID, or second parameters from which the PRS-ID can be determined, or a combination thereof, the PRS-ID corresponding to a positioning reference signal sequence; and
determine the candidate sequence according to:

Candidate sequence=g^{PRS-ID}h^{r}mod(p).

Clause 73. A network entity comprising:
a transceiver;
a memory; and
a processor, communicatively coupled to the memory and the transceiver, configured to:
   produce a commitment sequence by applying a commitment scheme to a first reference signal;
   transmit, via the transceiver, the commitment sequence; and
   transmit, via the transceiver after the commitment sequence is transmitted, a transmission signal including the first reference signal.

Clause 74. The network entity of clause 73, wherein the transmission signal includes a decoding portion, wherein the transmission signal has a transmission schedule of the first reference signal and the decoding portion, wherein the decoding portion comprises information to decode the first reference signal to produce a second reference signal, wherein the decoding portion is scheduled in one or more first symbols of the transmission schedule and the first reference signal is scheduled in one or more second symbols of the transmission schedule, and wherein none of the one or more first symbols is earlier than any of the one or more second symbols.

Clause 75. The network entity of clause 73, wherein the commitment scheme comprises a one-way function, and wherein to produce the commitment scheme the processor is configured to apply the one-way function to the first reference signal and to a private key of the network entity.

Clause 76. The network entity of clause 73, wherein to produce the commitment sequence the processor is further configured to determine the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 77. A reference signal transmission method comprising:
producing a commitment sequence by applying, at a network entity, a commitment scheme to a first reference signal;
transmitting, from the network entity, the commitment sequence; and
transmitting, from the network entity after the commitment sequence is transmitted, a transmission signal including the first reference signal.

Clause 78. The reference signal transmission method of clause 77, wherein the transmission signal includes a decoding portion, wherein the transmission signal has a transmission schedule of the first reference signal and the decoding portion, wherein the decoding portion comprises information to decode the first reference signal to produce a second reference signal, wherein the decoding portion is scheduled in one or more first symbols of the transmission schedule and the first reference signal is scheduled in one or more second symbols of the transmission schedule, and wherein none of the one or more first symbols is earlier than any of the one or more second symbols.

Clause 79. The reference signal transmission method of clause 77, wherein the commitment scheme comprises a one-way function, and wherein producing the commitment scheme comprises applying the one-way function to the first reference signal and to a private key of the network entity.

Clause 80. The reference signal transmission method of clause 77, wherein producing the commitment sequence comprises determining the commitment sequence according to:

Commitment sequence=g^{PRS-ID}h^{r}mod(p)

where p is a prime number, g is a number in [2, p-1], h is an element in [2, p-1] such that log_{g}h is unknown, PRS-ID corresponds to a positioning reference signal sequence, and r is a random number.

Clause 81. A network entity comprising:
means for producing a commitment sequence by applying a commitment scheme to a first reference signal;
means for transmitting the commitment sequence; and
means for transmitting, after the commitment sequence is transmitted, a transmission signal including the first reference signal.

Clause 82. The network entity of clause 81, wherein the transmission signal includes a decoding portion, wherein the transmission signal has a transmission schedule of the first reference signal and the decoding portion, wherein the decoding portion comprises information to decode the first reference signal to produce a second reference signal, wherein the decoding portion is scheduled in one or more first symbols of the transmission schedule and the first reference signal is scheduled in one or more second symbols of the transmission schedule, and wherein none of the one or more first symbols is earlier than any of the one or more second symbols.

Clause 83. The network entity of clause 81, wherein the commitment scheme comprises a one-way function, and wherein the means for producing the commitment scheme comprise means for applying the one-way function to the first reference signal and to a private key of the network entity.

Clause 84. The network entity of clause 81, wherein the means for producing the commitment sequence comprise means for determining the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 85. A non-transitory, processor-readable storage medium comprising processor-readable instructions to cause a processor of a network entity to:
produce a commitment sequence by applying a commitment scheme to a first reference signal;
transmit the commitment sequence; and
transmit, after the commitment sequence is transmitted, a transmission signal including the first reference signal.

Clause 86. The non-transitory, processor-readable storage medium of clause 85, wherein the transmission signal includes a decoding portion, wherein the transmission signal has a transmission schedule of the first reference signal and the decoding portion, wherein the decoding portion comprises information to decode the first reference signal to produce a second reference signal, wherein the decoding portion is scheduled in one or more first symbols of the transmission schedule and the first reference signal is scheduled in one or more second symbols of the transmission schedule, and wherein none of the one or more first symbols is earlier than any of the one or more second symbols.

Clause 87. The non-transitory, processor-readable storage medium of clause 85, wherein the commitment scheme comprises a one-way function, and wherein the processor-readable instructions to cause the processor to produce the commitment scheme comprise the processor-readable instructions to cause the processor to apply the one-way function to the first reference signal and to a private key of the network entity.

Clause 88. The non-transitory, processor-readable storage medium of clause 85, wherein the processor-readable instructions to cause the processor to produce the commitment sequence comprise the processor-readable instructions to cause the processor to determine the commitment sequence according to:

Commitment sequence=g^{PRS-ID}h^{r}mod(p)
where p is a prime number, g is a number in [2, p-1], h is an element in [2, p-1] such that log_{g}h is unknown, PRS-ID corresponds to a positioning reference signal sequence, and r is a random number.

Clause 89. A user equipment comprising:
a transceiver;
a memory; and
a processor, communicatively coupled to the memory and the transceiver, configured to:
   receive a reference signal from a network entity;
   receive, from the network entity, a commitment sequence corresponding to the reference signal and to a commitment scheme:
      apply a function to the reference signal to produce a candidate sequence, the function corresponding to the commitment scheme; and
      determine whether the candidate sequence has an acceptable relationship with respect to the commitment sequence.

Clause 90. The user equipment of clause 89, wherein the processor is further configured to disregard the reference signal, or a measurement corresponding thereto, in response to determining that the candidate sequence has an unacceptable relationship with respect to the commitment sequence.

Clause 91. The user equipment of clause 89, wherein to produce the candidate sequence the processor is further configured to apply the function to a public encryption key of the network entity.

Clause 92. The user equipment of clause 89, wherein the processor is further configured to:
obtain a transmission schedule of a transmission signal, the transmission signal comprising at least one decoding portion and at least one reference signal portion corresponding to the reference signal, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is earlier than any of the one or more second symbols;
receive the transmission signal, wherein each of the at least one decoding portion comprises decoding information to decode a corresponding one of the at least one reference signal portion;
determine the decoding information from each of the at least one decoding portion;
decode each of the at least one reference signal portion using the decoding information of a corresponding one of the at least one decoding portion, to produce a decoded signal; and
determine a reference signal measurement using the decoded signal.

Clause 93. A reference signal verification method comprising:
receiving a reference signal at a user equipment from a network entity;
receiving, at the user equipment from the network entity, a commitment sequence corresponding to the reference signal and to a commitment scheme;
applying, at the user equipment, a function to the reference signal to produce a candidate sequence, the function corresponding to the commitment scheme; and
determining, at the user equipment, whether the candidate sequence has an acceptable relationship with respect to the commitment sequence.

Clause 94. The reference signal verification method of clause 93, further comprising disregarding the reference signal, or a measurement corresponding thereto, in response to determining that the candidate sequence has an unacceptable relationship with respect to the commitment sequence.

Clause 95. The reference signal verification method of clause 93, wherein applying the function to produce the candidate sequence further comprises applying the function to a public encryption key of the network entity.

Clause 96. The reference signal verification method of clause 93, further comprising:
obtaining, at the user equipment, a transmission schedule of a transmission signal, the transmission signal comprising at least one decoding portion and at least one reference signal portion corresponding to the reference signal, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is earlier than any of the one or more second symbols;
receiving, at the user equipment, the transmission signal, wherein each of the at least one decoding portion comprises decoding information to decode a corresponding one of the at least one reference signal portion;
determining the decoding information, at the user equipment, from each of the at least one decoding portion;
decoding, at the user equipment, each of the at least one reference signal portion, using the decoding information of a corresponding one of the at least one decoding portion, to produce a decoded signal; and
determining, at the user equipment, a reference signal measurement using the decoded signal.

Clause 97. A user equipment comprising:
means for receiving a reference signal from a network entity;
means for receiving, from the network entity, a commitment sequence corresponding to the reference signal and to a commitment scheme;
means for applying a function to the reference signal to produce a candidate sequence, the function corresponding to the commitment scheme; and
means for determining whether the candidate sequence has an acceptable relationship with respect to the commitment sequence.

Clause 98. The user equipment of clause 97, further comprising means for disregarding the reference signal, or a measurement corresponding thereto, in response to determining that the candidate sequence has an unacceptable relationship with respect to the commitment sequence.

Clause 99. The user equipment of clause 97, wherein the means for applying the function to produce the candidate sequence comprise means for applying the function to a public encryption key of the network entity.

Clause 100. The user equipment of clause 97, further comprising:
means for obtaining a transmission schedule of a transmission signal, the transmission signal comprising at least one decoding portion and at least one reference signal portion corresponding to the reference signal, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is earlier than any of the one or more second symbols;
means for receiving the transmission signal, wherein each of the at least one decoding portion comprises decoding information to decode a corresponding one of the at least one reference signal portion;
means for determining the decoding information from each of the at least one decoding portion;
means for decoding each of the at least one reference signal portion, using the decoding information of a corresponding one of the at least one decoding portion, to produce a decoded signal; and
means for determining a reference signal measurement using the decoded signal.

Clause 101. A non-transitory, processor-readable storage medium comprising processor-readable instructions to cause a processor of a user equipment to:
receive a reference signal from a network entity;
receive, from the network entity, a commitment sequence corresponding to the reference signal and to a commitment scheme;
apply a function to the reference signal to produce a candidate sequence, the function corresponding to the commitment scheme; and
determine whether the candidate sequence has an acceptable relationship with respect to the commitment sequence.

Clause 102. The non-transitory, processor-readable storage medium of clause 101, further comprising processor-readable instructions to cause the processor to disregard the reference signal, or a measurement corresponding thereto, in response to determining that the candidate sequence has an unacceptable relationship with respect to the commitment sequence.

Clause 103. The non-transitory, processor-readable storage medium of clause 101, wherein the processor-readable instructions to cause the processor to apply the function to produce the candidate sequence comprise processor-readable instructions to cause the processor to apply the function to a public encryption key of the network entity.

Clause 104. The non-transitory, processor-readable storage medium of clause 101, further comprising processor-readable instructions to cause the processor to:
obtain a transmission schedule of a transmission signal, the transmission signal comprising at least one decoding portion and at least one reference signal portion corresponding to the reference signal, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is earlier than any of the one or more second symbols;
receive the transmission signal, wherein each of the at least one decoding portion comprises decoding information to decode a corresponding one of the at least one reference signal portion;
determine the decoding information from each of the at least one decoding portion;
decode each of the at least one reference signal portion, using the decoding information of a corresponding one of the at least one decoding portion, to produce a decoded signal; and
determine a reference signal measurement using the decoded signal.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A network entity comprising:
a transceiver;
a memory; and
a processor, communicatively coupled to the memory and the transceiver, configured to:
determine a signal configuration of a transmission signal that comprises at least one decoding portion and at least one reference signal portion, wherein the signal configuration comprises a transmission schedule of the at least one decoding portion and the at least one reference signal portion, wherein each of the at least one decoding portion comprises decoding information to decode a corresponding one of the at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols; and
transmit, via the transceiver, the transmission signal.

2. The network entity of claim 1, wherein each symbol of the transmission signal comprises at most one of the at least one decoding portion, or at most one of the at least one reference signal portion, or a combination thereof.

3. The network entity of claim 2, wherein each symbol of the transmission signal comprises a single one of the at least one decoding portion and a single one of the at least one reference signal portion, and wherein for each symbol of the transmission signal, the decoding information of the single one of the at least one decoding portion contains information to decode the single one of the at least one reference signal portion.

4. The network entity of claim 1, wherein the at least one reference signal portion and the at least one decoding portion are scheduled in a sequence of subgroups of the transmission schedule, and wherein each of the at least one decoding portion is scheduled in a respective first subgroup of the sequence of subgroups and a corresponding one of the at least one reference signal portion is scheduled in a respective second subgroup of the sequence of subgroups that is immediately prior in the sequence of subgroups to the respective first subgroup of the sequence of subgroups.

5. The network entity of claim 1, wherein the at least one decoding portion comprises a first decoding portion and a second decoding portion and the at least one reference signal portion comprises a first reference signal portion and a second reference signal portion, and wherein the first decoding portion identifies the second decoding portion.

6. The network entity of claim 1, wherein the at least one reference signal portion comprises a plurality of reference signal portions and the at least one decoding portion is a single decoding portion for all of the plurality of reference signal portions, and wherein the single decoding portion is scheduled in a last symbol of the transmission signal in the transmission schedule.

7. The network entity of claim 1, wherein the at least one reference signal portion comprises a plurality of reference signal portions and the at least one decoding portion is a single decoding portion for all of the plurality of reference signal portions, and wherein the single decoding portion is scheduled after a last symbol of the plurality of reference signal portions of the transmission signal in the transmission schedule.

8. The network entity of claim 1, wherein the at least one reference signal portion and the at least one decoding portion are scheduled, in combination, in the transmission schedule according to a single comb number.

9. The network entity of claim 1, wherein the at least one reference signal portion is scheduled in the transmission schedule in first resource elements in accordance with a comb number and the at least one decoding portion is scheduled in the transmission schedule in second resource elements that are separate from the first resource elements.

10. The network entity of claim 1, wherein the processor is further configured to:
produce a commitment sequence by applying a commitment scheme to the at least one reference signal portion; and
transmit, via the transceiver, the commitment sequence before transmitting the transmission signal.

11. The network entity of claim 10, wherein the commitment scheme comprises a one-way function, and wherein to produce the commitment sequence the processor is further configured to apply the one-way function to the at least one reference signal portion and a private key of the network entity.

12. The network entity of claim 10, wherein to produce the commitment sequence the processor is further configured to determine the commitment sequence according to:
Commitment sequence=g^{PRS-ID}h^{r}mod(p)
where p is a prime number, g is a number in [2, p−1], h is an element in [2, p−1] such that log_{g}h is unknown, PRS-ID corresponds to a positioning reference signal sequence, and r is a random number.

13. A user equipment comprising:
a transceiver;
a memory; and
a processor, communicatively coupled to the memory and the transceiver, configured to:
obtain a transmission schedule of a transmission signal comprising at least one decoding portion and at least one reference signal portion, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is before any of the one or more second symbols;
receive, via the transceiver, the transmission signal, wherein each of the at least one decoding portion comprises decoding information to decode a corresponding one of the at least one reference signal portion;
determine, from each of the at least one decoding portion, the decoding information;
decode each of the at least one reference signal portion using the decoding information of a corresponding one of the at least one decoding portion, to produce a decoded signal; and
determine a reference signal measurement using the decoded signal.

14. The user equipment of claim 13, wherein the at least one decoding portion comprises a first decoding portion and a second decoding portion, and the at least one reference signal portion comprises a first reference signal portion and a second reference signal portion, and wherein the processor is configured to analyze the first decoding portion to identify the second decoding portion.

15. The user equipment of claim 13, wherein the processor is configured to store each of the at least one reference signal portion, based on the transmission schedule, until the processor receives a respective one of the at least one decoding portion and determines the decoding information.

16. The user equipment of claim 13, wherein the processor is further configured to:
receive, via the transceiver from a network entity, a verification sequence corresponding to the at least one reference signal portion;
produce a candidate sequence by applying a function to the at least one reference signal portion; and
determine whether the candidate sequence has an acceptable relationship with respect to the verification sequence.

17. The user equipment of claim 16, wherein to produce the candidate sequence the processor is further configured to apply the function to the at least one reference signal portion and a public encryption key of the network entity.

18. The user equipment of claim 16, wherein to produce the candidate sequence the processor is further configured to:
receive, via the transceiver, first parameters p, g, h, and r, where p is a prime number, g is a number in [2, p−1], h is an element in [2, p−1] such that log_{g}h is unknown;
receive, via the transceiver, a PRS-ID, or second parameters from which the PRS-ID can be determined, or a combination thereof, the PRS-ID corresponding to a positioning reference signal sequence; and
determine the candidate sequence according to:
Candidate sequence=g^{PRS-ID}h^{r}mod(p).

19. A network entity comprising:
a transceiver;
a memory; and
a processor, communicatively coupled to the memory and the transceiver, configured to:
produce a commitment sequence by applying a commitment scheme to a first reference signal;
transmit, via the transceiver, the commitment sequence; and
transmit, via the transceiver after the commitment sequence is transmitted, a transmission signal including the first reference signal.

20. The network entity of claim 19, wherein the transmission signal includes a decoding portion, wherein the transmission signal has a transmission schedule of the first reference signal and the decoding portion, wherein the decoding portion comprises information to decode the first reference signal to produce a second reference signal, wherein the decoding portion is scheduled in one or more first symbols of the transmission schedule and the first reference signal is scheduled in one or more second symbols of the transmission schedule, and wherein none of the one or more first symbols is earlier than any of the one or more second symbols.

21. The network entity of claim 19, wherein the commitment scheme comprises a one-way function, and wherein to produce the commitment scheme the processor is configured to apply the one-way function to the first reference signal and to a private key of the network entity.

22. The network entity of claim 19, wherein to produce the commitment sequence the processor is further configured to determine the commitment sequence according to:
Commitment sequence=g^{PRS-ID}h^{r}mod(p)
where p is a prime number, g is a number in [2, p−1], h is an element in [2, p−1] such that log_{g}h is unknown, PRS-ID corresponds to a positioning reference signal sequence, and r is a random number.

23. A user equipment comprising:
a transceiver;
a memory; and
a processor, communicatively coupled to the memory and the transceiver, configured to:
receive a reference signal from a network entity;
receive, from the network entity, a commitment sequence corresponding to the reference signal and to a commitment scheme;
apply a function to the reference signal to produce a candidate sequence, the function corresponding to the commitment scheme; and
determine whether the candidate sequence has an acceptable relationship with respect to the commitment sequence.

24. The user equipment of claim 23, wherein the processor is further configured to disregard the reference signal, or a measurement corresponding thereto, in response to determining that the candidate sequence has an unacceptable relationship with respect to the commitment sequence.

25. The user equipment of claim 23, wherein to produce the candidate sequence the processor is further configured to apply the function to a public encryption key of the network entity.

26. The user equipment of claim 23, wherein the processor is further configured to:
obtain a transmission schedule of a transmission signal, the transmission signal comprising at least one decoding portion and at least one reference signal portion corresponding to the reference signal, wherein each of the at least one decoding portion is scheduled in one or more first symbols of the transmission schedule and the corresponding one of the at least one reference signal portion is scheduled in one or more second symbols of the transmission schedule, and wherein none of the one or more first symbols is earlier than any of the one or more second symbols;
receive the transmission signal, wherein each of the at least one decoding portion comprises decoding information to decode a corresponding one of the at least one reference signal portion;
determine the decoding information from each of the at least one decoding portion;
decode each of the at least one reference signal portion using the decoding information of a corresponding one of the at least one decoding portion, to produce a decoded signal; and
determine a reference signal measurement using the decoded signal.
